(19) United States
(12) Patent Application Publication
(10) Pub. No.: US 2024/0330114 A1
(43) Pub. Date: Oct. 3, 2024

(54) BACKUP SYSTEM AND BACKUP METHOD

(71) Applicant: Hitachi, Ltd., Tokyo (JP)

(72) Inventors: Natsumi AKIBA, Tokyo (JP); Goro KAZAMA, Tokyo (JP); Hidenobu MURAMATSU, Tokyo (JP); Takeyuki IMADU, Tokyo (JP)

(21) Appl. No.: 18/243,273

(22) Filed: Sep. 7, 2023

(30) Foreign Application Priority Data
Mar. 27, 2023 (JP) 2023-050534

(51) Int. Cl. G06F 11/14

(52) U.S. Cl. CPC G06F 11/1451; G06F 11/1464

(57) ABSTRACT

One of objects of the present invention is to provide a backup system and a backup method that make it possible to improve availability by increasing the number of paths for acquiring backups to be stored in a data protection area. A backup storage apparatus includes a first storage, a second storage, and a BP storage. The BP storage has a first backup volume, a second backup volume, and a data protection area. The BP storage stores first route BP images and second route BP images in the data protection area such that generations of the first route BP images and generations of the second route BP images do not overlap.

### CROSS-REFERENCE TO RELATED APPLICATION

The present application claims priority from Japanese application JP2023-050534, filed on Mar. 27, 2023, the content of which is hereby incorporated by reference into this application.

### BACKGROUND OF THE INVENTION

### 1. Field of the Invention

The present invention relates to a backup system and a backup method.

### 2. Description of the Related Art

Since cyber attacks have become more sophisticated and destruction-of-service (DeOS) type attacks that destroy backup data have appeared in recent years, conventional cyber security measures alone are no longer sufficient for protection of organizations from unceasing cyber attacks. In view of such a circumstance, solutions aimed not for avoiding attacks but for being capable of rapid data recovery (“cyber resilience”) even if there are attacks have started being proposed on the market, and there is a tendency that having such solutions is an essential requirement on the main frame (MF) market.

There are technologies for conventional storage systems in which a storage function is used to create, in an externally inaccessible data protection area, backups of data that is read and written by a host. An example of the technologies is disclosed in JP-2021-22390-A (hereinafter, referred to as Patent Document 1), for example. In a backup system disclosed by Patent Document 1, there is one backup acquisition path, and acquired backups are stored in a data protection area. Note that JP-2003-242011-A (hereinafter, referred to as Patent Document 2) is available as a technology for acquiring a plurality of backups. In the technology of Patent Document 2, snapshots of volumes used by a host are duplicated for each generation in different storage apparatuses.

### SUMMARY OF THE INVENTION

There is a problem of availability regarding the backup system of Patent Document 1 since the number of paths for acquiring backups to be stored in the data protection area is one. The technology of Patent Document 2 is simply a technology for duplicating backups (snapshots), and is not a technology for acquiring backups as targets to be stored in a data protection area through a plurality of paths. The present invention has been made to solve the problems described above. That is, one of objects of the present invention is to provide a backup system and a backup method that make it possible to improve availability by increasing the number of paths for acquiring backups to be stored in a data protection area.

In order to solve the problem described above, a backup system of the present invention includes a plurality of storage apparatuses each of which is used to configure one of a plurality of backup routes that are different for a common backup target, and a backup storage apparatus having a plurality of backup volumes corresponding to a plurality of the backup routes and a data protection area that is a storage area not accessible from an external apparatus. The backup storage apparatus stores each copy of common backup-target data in one of a plurality of the backup volumes through one of a plurality of the backup routes, and stores backup images of a plurality of generations for respective ones of a plurality of the backup volumes in the data protection area.

A backup method of the present invention is a backup method using a plurality of storage apparatuses and a backup storage apparatus having a plurality of backup volumes and a data protection area that is a storage area not accessible from an external apparatus. The backup method includes forming a plurality of backup routes that are different for a common backup target, by a plurality of the storage apparatuses, storing, by the backup storage apparatus, each copy of common backup-target data in one of a plurality of the backup volumes through one of a plurality of the backup routes, and storing, by the backup storage apparatus, backup images of a plurality of generations for respective ones of a plurality of the backup volumes in the data protection area.

The present invention can improve availability by increasing the number of paths for acquiring backups to be stored in a data protection area. Note that the advantage described here is not necessarily the only one, and there may be any of advantages described in the present disclosure.

### BRIEF DESCRIPTION OF THE DRAWINGS

FIG. 1 is a configuration diagram depicting a configuration example of a backup system according to a first embodiment of the present invention;

FIG. 2 is a block diagram depicting an example of a hardware block configuration of a storage apparatus;

FIG. 3 is a schematic configuration diagram depicting a configuration example of a management server;

FIG. 4 is a schematic configuration diagram depicting a configuration example of a verifying server;

FIG. 5A is a figure for explaining a volume copy management table of a first storage;

FIG. 5B is a figure for explaining a first True Copy management table of the first storage;

FIG. 5C is a figure for explaining a first external connection mapping table of the first storage;

FIG. 6A is a figure for explaining a volume copy management table of a second storage;

FIG. 6B is a figure for explaining a second True Copy management table of the second storage;

FIG. 6C is a figure for explaining a second external connection mapping table of the second storage;

FIG. 7 is a figure for explaining a backup route management table;

FIG. 8 is a figure for explaining a backup route execution result management table;

FIG. 9A is a figure for explaining a first backup data management table;

FIG. 9B is a figure for explaining a second backup data management table;

FIG. 10 is a figure for explaining a backup generation information management table;

FIG. 11 is a figure for explaining a third external connection mapping table;

FIG. 12 is a figure for explaining a linkage table;

FIG. 13 is a figure for explaining a fourth external connection mapping table;

FIG. 14A is a figure for explaining an overview of an operation performed by the backup system;

FIG. 14B is a figure for explaining the overview of the operation performed by the backup system;

FIG. 14C is a figure for explaining the overview of the operation performed by the backup system;

FIG. 14D is a figure for explaining the overview of the operation performed by the backup system;

FIG. 15A is a figure for explaining an overview of an operation performed by the backup system in a case where a failure has occurred in one of backup routes;

FIG. 15B is a figure for explaining the overview of the operation performed by the backup system in the case where the failure has occurred in the one of the backup routes;

FIG. 15C is a figure for explaining the overview of the operation performed by the backup system in the case where the failure has occurred in the one of the backup routes;

FIG. 15D is a figure for explaining the overview of the operation performed by the backup system in the case where the failure has occurred in the one of the backup routes;

FIG. 16A is a figure for explaining an overview of an operation performed by the backup system after recovery;

FIG. 16B is a figure for explaining the overview of the operation performed by the backup system after the recovery;

FIG. 16C is a figure for explaining the overview of the operation performed by the backup system after the recovery;

FIG. 16D is a figure for explaining the overview of the operation performed by the backup system after the recovery;

FIG. 16E is a figure for explaining the overview of the operation performed by the backup system after the recovery;

FIG. 16F is a figure for explaining the overview of the operation performed by the backup system after the recovery;

FIG. 17 is a flowchart depicting a processing procedure executed by a central processing unit (CPU) of the management server;

FIG. 18 is a flowchart depicting a processing procedure executed by the CPU of the management server;

FIG. 19 is a flowchart depicting a processing procedure executed by a CPU of the verifying server;

FIG. 20 is a figure depicting an example of a graphical user interface (GUI) screen displayed on a display;

FIG. 21A is a figure for explaining an overview of an operation performed by the backup system;

FIG. 21B is a figure for explaining the overview of the operation performed by the backup system;

FIG. 22A is a figure for explaining an advantage of the backup system;

FIG. 22B is a figure for explaining the advantage of the backup system; and

FIG. 23 is a flowchart depicting a processing procedure executed by the CPU of the management server.

### DESCRIPTION OF THE PREFERRED EMBODIMENTS

Hereinbelow, each embodiment of the present invention is explained with reference to the drawings. Note that identical or corresponding portions throughout all the drawings depicting the embodiments are given identical reference characters in some cases.

In the following explanation, various types of information are explained with use of such expressions as a “table” or a “record” in some cases, and the various types of information may be expressed by data structures other than these. When identification information is explained, such expressions as an “ID,” a “name,” or a “number” are used, and these are mutually interchangeable. For convenience of explanation, it is assumed that identifications (IDs) of volumes and storages are the same as reference characters (numbers) given to the volumes and the storages. In the following explanation, the subject of a sentence explaining a process is a CPU or an apparatus in some cases. The subject of the sentence explaining the process may be the apparatus or a program instead of the CPU, or may be the CPU or a controller instead of the apparatus.

### First Embodiment

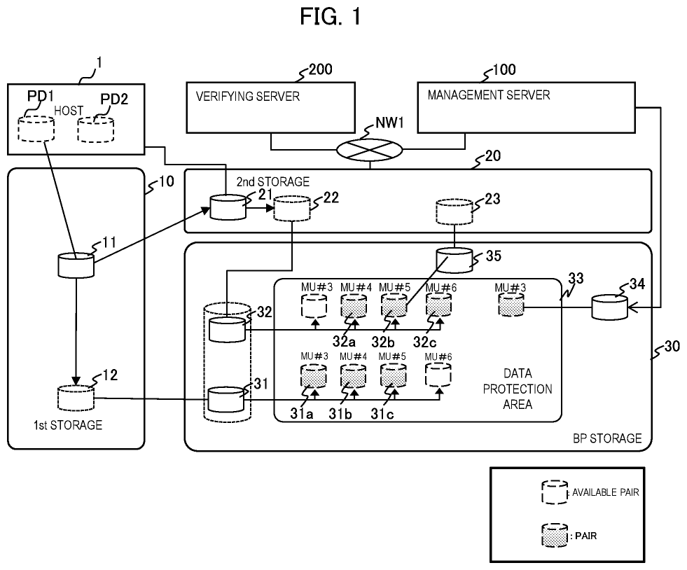

FIG. 1 is a configuration diagram depicting a configuration example of a backup system according to a first embodiment of the present invention. As depicted in FIG. 1, the backup system has a host 1, a first storage system 10 (hereinafter, called a “first storage 10”), a second storage system 20 (hereinafter, called a “second storage 20”), a backup storage system 30 (hereinafter, called a “BP storage 30”), a management server 100, and an verifying server 200. The first storage 10 is also called a “first storage apparatus” in some cases. A second storage 20 is also called a “second storage apparatus” in some cases. The BP storage 30 is also called a “backup storage apparatus” in some cases.

Note that, in the present example, the host 1, the first storage 10, the second storage 20, and the verifying server 200 are typically included in a main frame system (hereinafter, called an “MF”). The management server 100 and the BP storage 30 are typically included in an open system.

The host 1 is connected to the first storage 10. The first storage 10 provides the host 1 with a production volume 11 which is a logical volume. When the production volume 11 is mounted on the host 1, the host 1 recognizes the production volume 11 as a production PD1.

For example, the first storage 10 typically is a storage installed at a short distance from the host 1, and has the production volume 11 and a virtual volume 12. The production volume 11 is a target volume of an I/O request from the host 1. The virtual volume 12 is a virtually created virtual volume to be a secondary volume of the production volume 11 by Shadow Image (SI). Note that Shadow Image (SI) is a function to copy, in a secondary volume, all pieces of data of a primary volume in the same storage system.

The second storage 20 is connected to the first storage 10 through a network which is not depicted. For example, the second storage 20 is typically installed at a location far from the first storage 10. The second storage 20 has a replica volume 21 which is a logical volume, a virtual volume 22, and a virtual volume 23.

In the second storage 20, the replica volume 21 which is a copy of the production volume 11 of the first storage 10 is created by True Copy. The replica volume 21 is synchronized with the production volume 11 by True Copy, and the identicalness between the production volume 11 and the replica volume 21 is guaranteed. In True Copy, data is copied to the replica volume 21 of the second storage 20 in synchronization with data of the production volume 11 of the first storage 10. In response to a data write order from the host 1, data is written in the first storage 10, and then a completion response is returned to the host 1 after copying of the data to the second storage 20 is ended. In True Copy, all pieces of data written in the production volume 11 of the first storage 10 are copied to the replica volume 21 of the second storage 20.

The virtual volume 22 is a virtually created virtual volume to be a secondary volume of the replica volume 21 by Shadow Image (SI).

The virtual volume 23 is a virtually created virtual volume.

The virtual volume 23 performs mapping with the access volume 35 by treating the virtual volume 23 as an external connection source and an access volume 35 of the BP storage 30 as an external connection destination.

The BP storage 30 is connected with the first storage 10 and the second storage 20, and, for example, is installed at a location far from the first storage 10, and the second storage 20.

The BP storage 30 has a first backup volume 31, a second backup volume 32, a data protection area 33, a management data volume 34 and an access volume 35.

By an external connection function, the first backup volume 31 is mapped to the virtual volume 12 of the first storage 10, serves as a data storage destination of the virtual volume 12, and stores copies of data of the production volume 11. For example, the external connection function is realized by Universal Volume Manager (UVM) made available by Hitachi, Ltd. The external connection function is a function to integrate, by a virtualization technology, a plurality of disk arrays of different models as if they were one disk array, and is a function that can connect external storages and map logical volumes thereof to thereby treat the plurality of disk arrays of the different models as if they were the one disk array.

By the external connection function, the second backup volume 32 is mapped to the virtual volume 22 of the second storage 20, serves as a data storage destination of the virtual volume 22, and stores copies of data of the replica volume 21.

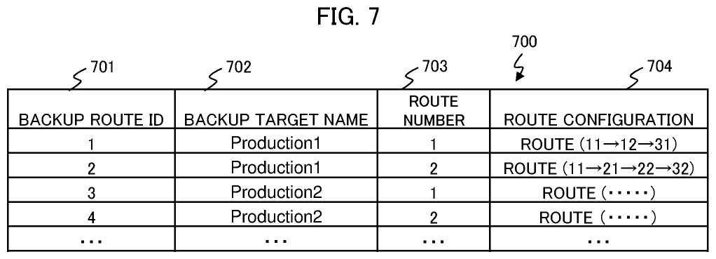

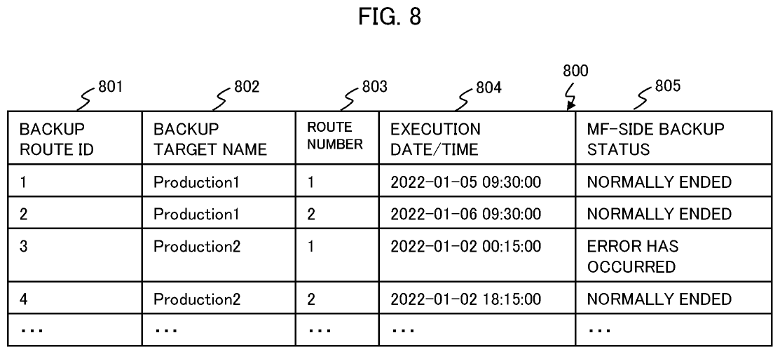

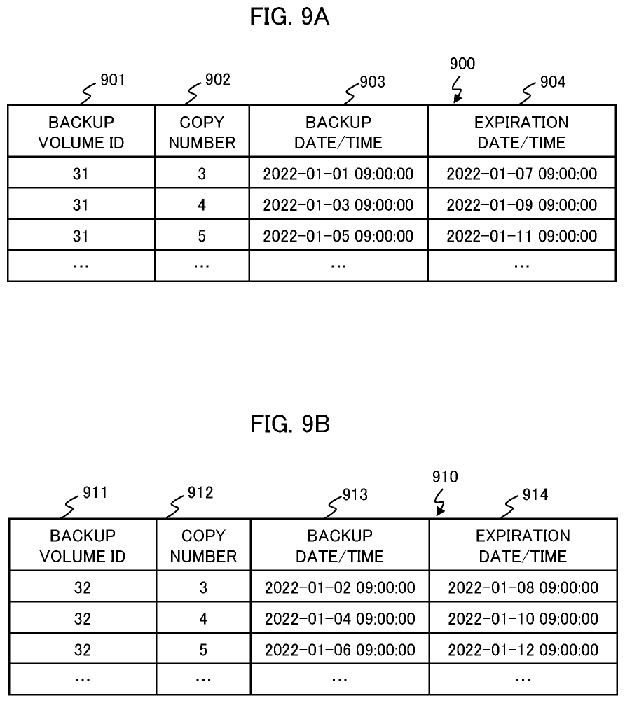

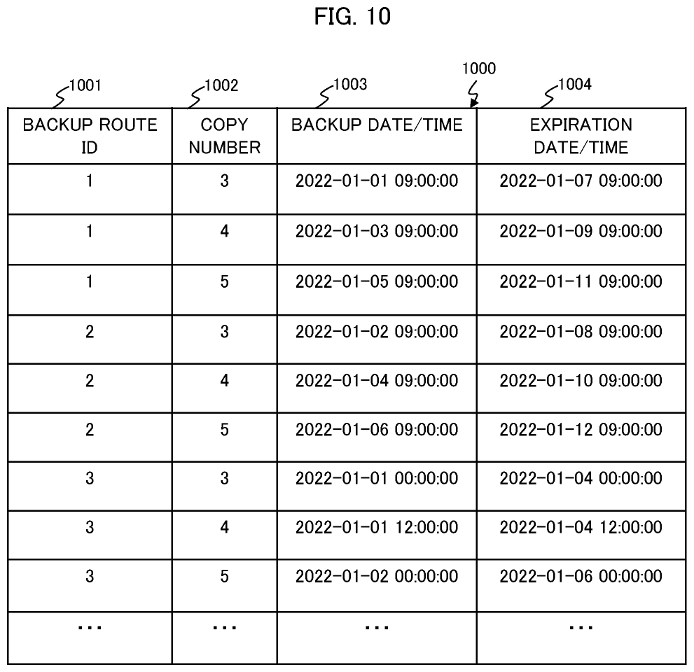

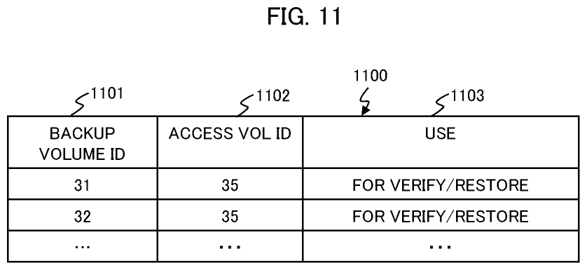

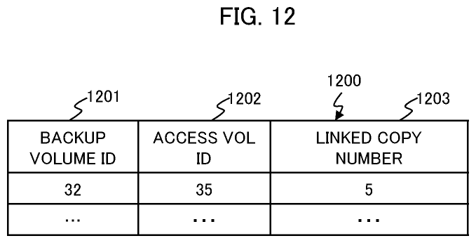

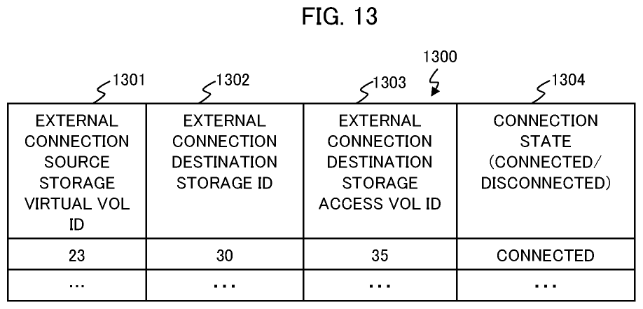

The management data volume 34 stores management information such as a backup route management table 700 (FIG. 7), a backup route execution result management table 800 (FIG. 8), a first backup data management table 900 (FIG. 9A), a second backup data management table 910 (FIG. 9B), a backup generation information management table 1000 (FIG. 10), a third external connection mapping table 1100 (FIG. 11), a linkage table 1200 (FIG. 12), and a fourth external connection mapping table 1300 (FIG. 13).

The data protection area 33 is an externally inaccessible area. Information for accessing this area from the outside is not provided to an external device, and the area is configured by using a storage area that can be recognized only by a storage controller of the BP storage 30. For example, in a case where the data protection area 33 is configured by using a plurality of volumes, volume IDs necessary for accessing data are not provided to the outside, in one possible manner of the configuration.

A backup image 31a, a backup image 31b, and a backup image 31c are backup images of the first backup volume 31 at different time points. For creating the backup images 31a, 31b, and 31c from the first backup volume 31, Thin Image in which only data before being updated in the first backup volume 31 is evacuated to pool volumes that are used to configure the data protection area 33 is used. It should be noted that another realization method may be adopted as long as it provides a function to acquire data that is used to configure a backup image at a specified time point of the first backup volume 31. In addition, a backup function that can store, in another volume, data that is used to configure a backup image may be used. Hereinbelow, data configured by using backup data at a predetermined time point is called a backup image in some cases.

A backup image 32a, a backup image 32b, and a backup image 32c are backup images of the second backup volume 32 at different time points. For creating the backup images 32a, 32b, and 32c from the second backup volume 32, Thin Image in which only data before being updated in the second backup volume 32 is evacuated to pool volumes that are used to configure the data protection area 33 is used. It should be noted that another realization method may be adopted as long as it provides a function to acquire data that is used to configure a backup image at a specified time point of the second backup volume 32. In addition, a backup function that can store, in another volume, data that is used to configure a backup image may be used.

Note that, as described above, the first backup volume 31 stores copies of data of the production volume 11. The second backup volume 32 stores copies of data of the replica volume 21 that is guaranteed to be identical with the production volume 11 owing to synchronized copying. Accordingly, backup images of the first backup volume 31 and backup images of the second backup volume 32 are backup images (backup data) of data copies of the production volume 11 (production PD1) which is a common backup target. As a result, it is possible to attempt to realize redundancy of backup routes, and availability can be ensured.

When the backup images 31a, 31b, and 31c are created, the storage controller of the BP storage 30 gives copy numbers #3, #4, and #5 to the respective images in accordance with an instruction from the management server 100, and manages the images with the management information of the management data volume 34. Since the backup images 31a, 31b, and 31c are images at time points specified by the first backup volume 31, they can be called generations of the first backup volume 31 at different time points.

When the backup images 32a, 32b, and 32c are created, the storage controller of the BP storage 30 gives copy numbers #3, #4, and #5 to the respective images in accordance with an instruction from the management server 100, and manages the images with the management information of the management data volume 34. Since the backup images 32a, 32b, and 32c are images at time points specified by the second backup volume 32, they can be called generations of the second backup volume 32 at different time points.

A backup image of the first backup volume 31 and a backup image of the second backup volume 32 at the same specified time point are backup images of the same generation (overlapping generations). Copy numbers to be given to (associated with) backup images of the first backup volume 31 are determined in order starting from #3 by the management server 100, and can increase and decrease by being deleted or added. Similarly, copy numbers given to (associated with) backup images of the second backup volume 32 are determined in order starting from #3 by the management server 100, and can increase and decease by being deleted (e.g., deleted starting from the smaller copy number) or added.

A determined copy number for which a backup image has not been acquired is called an “available pair.” A determined copy number for which a backup image has been acquired and a backup image to which the copy number is given are called a “pair.” The number of copy numbers (the number of pairs and available pairs) of the first backup volume 31 is called the number of pairs. Similarly, the number of copy numbers (the number of pairs and available pairs) of the second backup volume 32 is called the number of pairs.

In the example depicted in FIG. 1, the backup image 31a of the first backup volume 31 is given the copy number #3, the backup image 31b is given the copy number #4, and the backup image 31c is given the copy number #5. The backup image 32a of the second backup volume 32 is given the copy number #4, the backup image 32b is given the copy number #5, and the backup image 32c is given the copy number #6.

By association (also called “mapping”) of backup images of particular time points (particular generations) of the first backup volume 31 and the second backup volume 32 with the access volume 35, the backup images of the particular generations are provided to an external device (the second storage 20 in the present example). This mapping is an operation to associate a backup image (a copy number corresponding to the backup image) of a particular time point (particular generation) with the access volume 35 and provide the associated backup image by the access volume 35. For example, this operation is executed when the BP storage 30 receives a command from the management server 100. In such a manner that an original backup image itself is not modified, information written from the external connection side is stored as a difference in a temporary area, and is discarded when the association is disconnected.

It should be noted that, since data that is used to configure backup images of the access volume 35 is stored in the first backup volume 31 and the backup images 31a, 31b, and 31c as well as the second backup volume 32 and the backup images 32a, 32b, and 32c, access to the data is typically slow as compared with access to volumes storing all pieces of copied data that is used to configure the backup images.

Note that, regarding management information stored in the management data volume 34 also, backup images are stored in the data protection area 33, and copy numbers are given to the backup images, similarly to data stored in the first backup volume 31. The backup images of the management information are also linked with the management data volume 34, and the backup images thereby become accessible from external devices including the management server 100. The management data volume 34 and the access volume 35 are given information (e.g., volume IDs) that is necessary for access from the outside, and function as normal volumes.

### Hardware Configuration

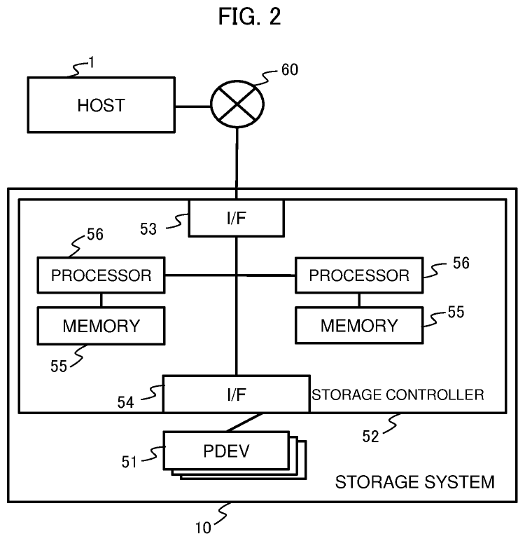

FIG. 2 is a block diagram depicting an example of a hardware block configuration of a storage system. The storage system in FIG. 2 corresponds to each of the first storage 10, the second storage 20, and the BP storage 30 in FIG. 1.

Whereas an explanation is given with reference to FIG. 2 taking the first storage 10 as an example, a similar configuration also applies to the other storage systems. The first storage 10 has PDEVs 51 which are a plurality of physical storage devices (or a PDEV 51 which is one storage device) and a storage controller 52 connected to the PDEVs 51.

The storage controller 52 has an I/F 53, an I/F 54, two memories 55, and two processors 56 connected to the two memories 55.

The I/F 53 is a communication interface device that intermediates data exchange between an external apparatus (e.g., the first host 1) and the storage controller 52. The I/F 53 is connected with the first host 1 and the BP storage 30 through a fibre channel (FC) network 60.

The first host 1 transmits, to the storage controller 52, an I/O request (a write request or a read request) specifying an I/O destination (e.g., a logical volume number such as a logical unit number (LUN) or a logical address such as a logical block address (LBA)).

The I/F 54 is a communication interface device that intermediates data exchange between the plurality of PDEVs 51 and the storage controller 52. The I/F 54 is connected with the plurality of PDEVs 51.

The memory 55 stores a program executed by the processor 56 and data used by the processor 56. The processor 56 executes the program stored on the memory 55. Note that there are duplicated sets of the memories 55 and the processors 56 in the present example.

Whereas the configuration of the first storage 10 is depicted in the description above, the other storages also have I/Fs, and are connected with external apparatuses, similarly. For example, the second storage 20 is connected to the first storage 10, the host 1, and the BP storage 30. The BP storage 30 is connected to the first storage 10 and the second storage 20.

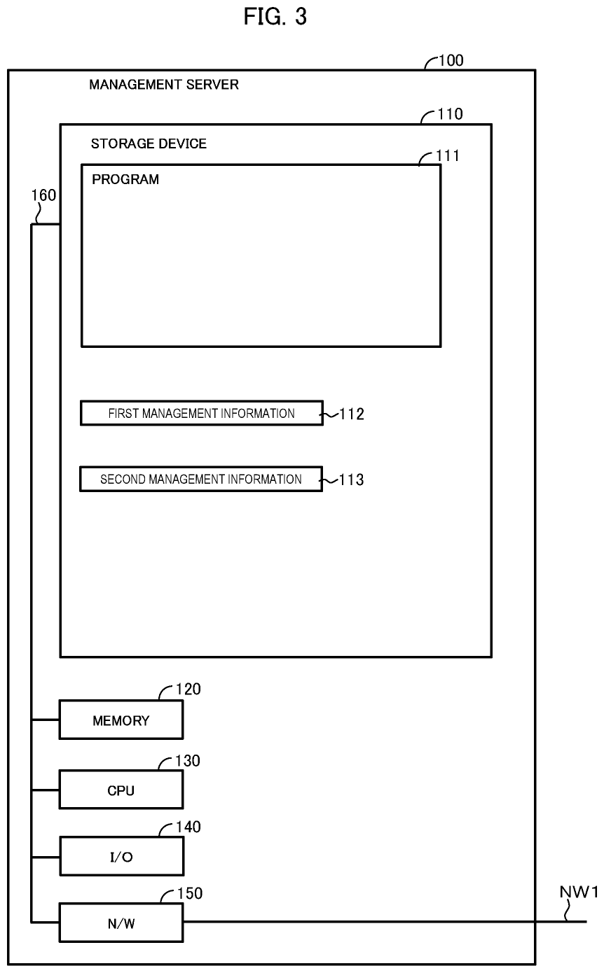

FIG. 3 is a schematic configuration diagram depicting a configuration example of the management server 100. As depicted in FIG. 3, the management server 100 includes a data-readable and data-writable non-volatile storage device 110, a memory 120 (e.g., a random access memory (RAM)), a CPU 130, an input/output interface 140, and a network interface 150. An apparatus including the CPU 130, the storage device 110, the memory 120, the input/output interface 140, the network interface 150, and a bus 160 is also called an “information processing apparatus,” for convenience. The information processing apparatus may be a virtual information processing apparatus built on a plurality of information processing apparatuses or a cloud computing system.

The storage device 110 retains (stores) programs 111, first management information 112, and second management information 113. The programs 111 include programs for realizing various types of functions of the management server 100.

The CPU 130 loads the programs 111 stored on the storage device 110 onto the memory 120. The CPU 130 is a computing device that realizes various types of functions of the management server 100 by executing the programs 111 loaded onto the memory 120.

The first management information 112 includes management information such as the backup route management table 700 (FIG. 7), the backup route execution result management table 800 (FIG. 8), the first backup data management table 900 (FIG. 9A), the second backup data management table 910 (FIG. 9B), the backup generation information management table 1000 (FIG. 10), the third external connection mapping table 1100 (FIG. 11), the linkage table 1200 (FIG. 12), and the fourth external connection mapping table 1300 (FIG. 13).

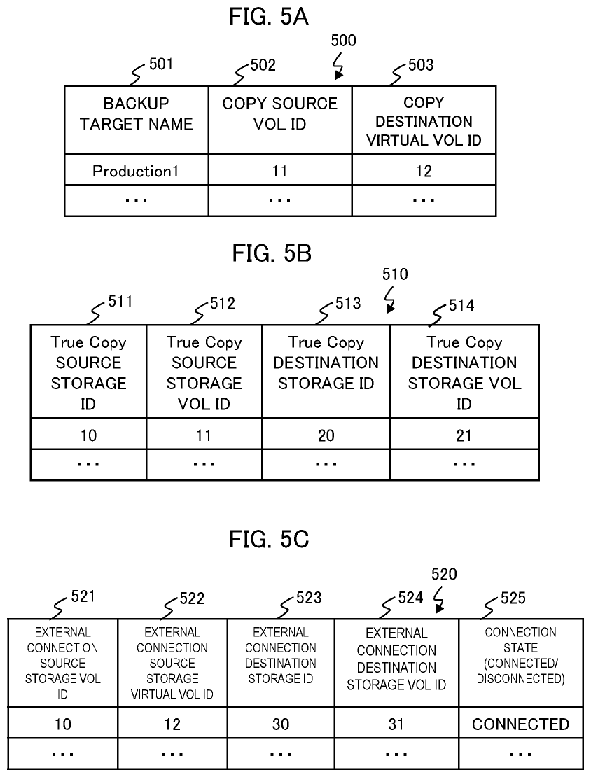

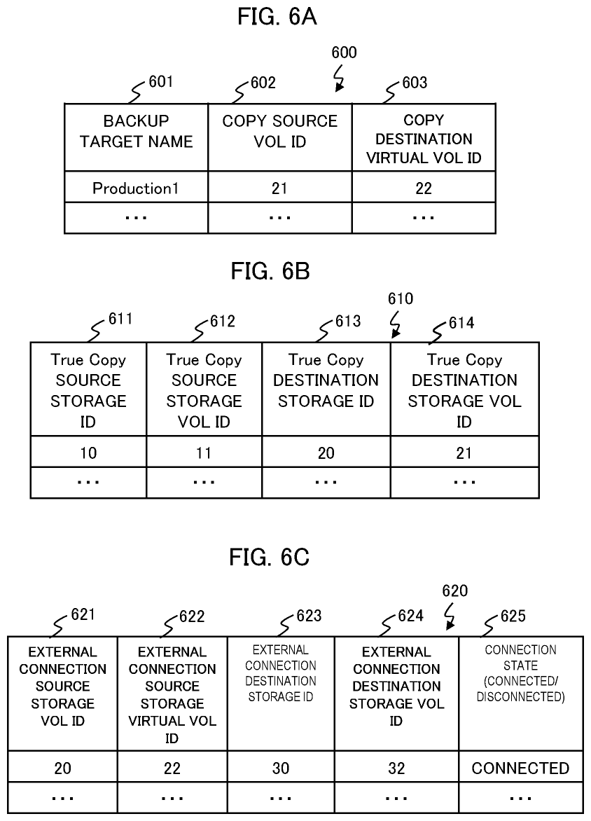

The second management information 113 is retained by the first storage 10 and the second storage 20 described in detail later, and includes various types of tables (FIG. 5A to FIG. 6C) acquired from the first storage 10 and the second storage 20.

The programs 111 executed by the CPU 130 are loaded onto the memory 120 as described above, and the memory 120 temporarily stores data to be used by the CPU 130 when the CPU 130 executes the programs 111.

The input/output interface 140 is an interface for connecting manipulation devices such as a keyboard and a mouse, a display, and the like. The network interface 150 is an interface for connecting the management server 100 to a network NW1 (e.g., a storage area network (SAN)).

Note that at least some of processes performed by the CPU 130 by executing the programs may be executed by another computing device (e.g., hardware such as an application-specific integrated circuit (ASIC) or a field-programmable gate array (FPGA)).

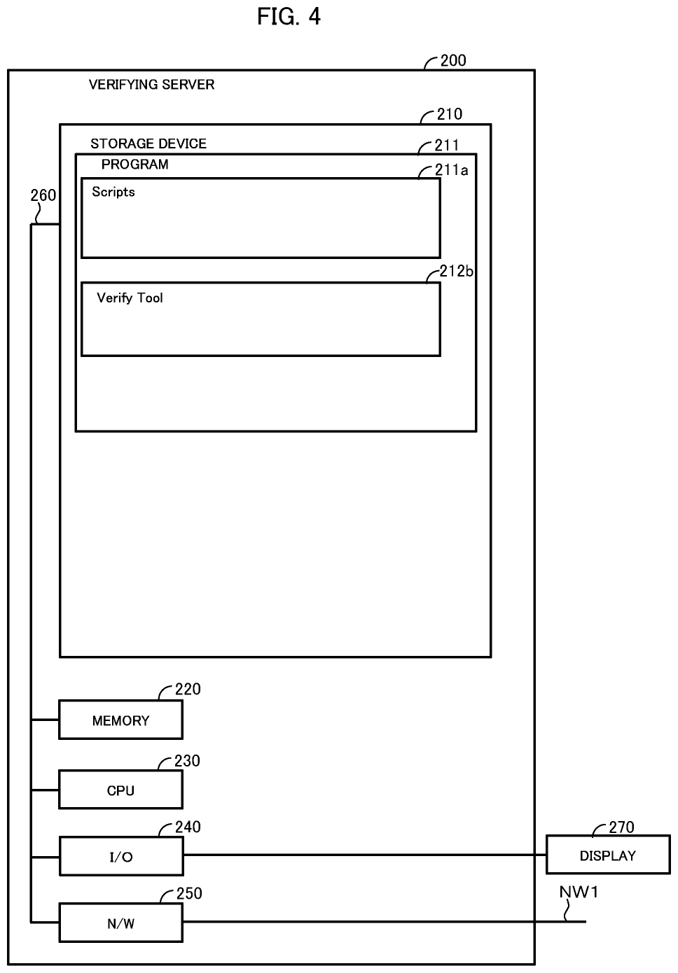

FIG. 4 is a schematic configuration diagram depicting a configuration example of the verifying server 200. The verifying server 200 performs verification of backup data. As depicted in FIG. 4, the verifying server 200 includes a data-readable and data-writable non-volatile storage device 210, a memory 220 (e.g., a RAM), a CPU 230, an input/output interface 240, and a network interface 250. An apparatus including the CPU 230, the storage device 210, the memory 220, the input/output interface 240, the network interface 250, and a bus 260 is also called an “information processing apparatus,” for convenience. The information processing apparatus may be a virtual information processing apparatus built on a plurality of information processing apparatuses or a cloud computing system.

The storage device 210 retains (stores) programs 211 including scripts 211a and a verify tool 212b.

The CPU 230 loads the programs 211 stored on the storage device 210 onto the memory 220. The CPU 230 is a computing device that realizes various types of functions such as a verification function of the verifying server 200 by executing the programs 211 loaded onto the memory 220.

The programs executed by the CPU 230 are loaded onto the memory 220 as described above, and the memory 220 temporarily stores data to be used by the CPU 230 when the CPU 230 executes the programs 211.

The input/output interface 240 is an interface for connecting manipulation devices such as a keyboard and a mouse, a display 270, and the like. The network interface 250 is an interface for connecting the verifying server 200 to the network NW1 (e.g., a SAN).

Note that at least some of processes performed by the CPU 230 by executing the programs may be executed by another computing device (e.g., hardware such as an ASIC or an FPGA.

FIG. 5A is a figure for explaining a first volume copy management table 500 of the first storage 10. As columns storing information (values), the first volume copy management table 500 includes a backup target name 501, a copy source VOL ID 502, and a copy destination virtual VOL ID 503. The first volume copy management table 500 has stored therein, as mutually-associated pieces of information (records) of each row, information corresponding to each column related to a copy of a volume. Specifically speaking, names of backup-target productions are stored in the backup target name 501. IDs for identifying production volumes recognized as the backup-target productions are stored in the copy source VOL ID 502. IDs for identifying secondary volumes of the production volume 11 are stored in the copy destination virtual VOL ID 503.

FIG. 5B is a figure for explaining a first True Copy management table 510 of the first storage 10. As columns storing information (values), the first True Copy management table 510 includes a True Copy source storage ID 511, a True Copy source storage VOL ID 512, a True Copy destination storage ID 513, and a True Copy destination storage VOL ID 514. The first True Copy management table 510 has stored therein, as mutually-associated pieces of information (records) of each row, information corresponding to each column related to True Copy.

Specifically speaking, IDs for identifying True Copy source storages are stored in the True Copy source storage ID 511. IDs for identifying primary volumes of True Copy in the True Copy source storages are stored in the True Copy source storage VOL ID 512. IDs for identifying True Copy destination storages are stored in the True Copy destination storage ID 513. IDs for identifying secondary volumes of True Copy in the True Copy destination storages are stored in the True Copy destination storage VOL ID 514.

FIG. 5C is a figure for explaining a first external connection mapping table 520 of the first storage 10. As columns storing information (values), the first external connection mapping table 520 includes an external connection source storage VOL ID 521, an external connection source storage virtual VOL ID 522, an external connection destination storage ID 523, an external connection destination storage VOL ID 524, and a connection state (connected/disconnected) 525. The first external connection mapping table 520 has stored therein, as mutually-associated pieces of information (records) of each row, information corresponding to each column related to a volume of the first storage 10 and an external volume mapped to the volume.

Specifically speaking, IDs for identifying external connection source storages are stored in the external connection source storage VOL ID 521. IDs for identifying mapped virtual volumes in the external connection source storages are stored in the external connection source storage virtual VOL ID 522. IDs for identifying external connection destination storages are stored in the external connection destination storage ID 523. IDs for identifying mapped volumes in the external connection destination storages are stored in the external connection destination storage VOL ID 524. Pieces of information representing the connection states of external connection are stored in the connection state (connected/disconnected) 525.

FIG. 6A is a figure for explaining a second volume copy management table 600 of the second storage 20. As columns storing information (values), the second volume copy management table 600 includes a backup target name 601, a copy source VOL ID 602, and a copy destination virtual VOL ID 603. The second volume copy management table 600 has stored therein, as mutually-associated pieces of information (records) of each row, information corresponding to each column related to a copy of a volume. Specifically speaking, names of backup-target productions are stored in the backup target name 601. IDs for identifying production volumes recognized as the backup-target productions are stored in the copy source VOL ID 602. IDs for identifying secondary volumes of the production volume 11 are stored in the copy destination virtual VOL ID 603.

FIG. 6B is a figure for explaining a second True Copy management table 610 of the second storage 20. As columns storing information (values), the second True Copy management table 610 includes a True Copy source storage ID 611, a True Copy source storage VOL ID 612, a True Copy destination storage ID 613, and a True Copy destination storage VOL ID 614. The second True Copy management table 610 has stored therein, as mutually-associated pieces of information (records) of each row, information corresponding to each column related to True Copy.

Specifically speaking, IDs for identifying True Copy source storages are stored in the True Copy source storage ID 611. IDs for identifying primary volumes of True Copy in the True Copy source storages are stored in the True Copy source storage VOL ID 612. IDs for identifying True Copy destination storages are stored in the True Copy destination storage ID 613. IDs for identifying secondary volumes of True Copy in the True Copy destination storages are stored in the True Copy destination storage VOL ID 614.

FIG. 6C is a figure for explaining a second external connection mapping table 620 of the second storage 20. As columns storing information (values), the second external connection mapping table 620 includes an external connection source storage VOL ID 621, an external connection source storage virtual VOL ID 622, an external connection destination storage ID 623, an external connection destination storage VOL ID 624, and a connection state (connected/disconnected) 625. The second external connection mapping table 620 has stored therein, as mutually-associated pieces of information (records) of each row, information corresponding to each column related to a volume of the second storage 20 and an external volume mapped to the volume.

Specifically speaking, IDs for identifying external connection source storages are stored in the external connection source storage VOL ID 621. IDs for identifying mapped virtual volumes in the external connection source storages are stored in the external connection source storage virtual VOL ID 622. IDs for identifying external connection destination storages are stored in the external connection destination storage ID 623. IDs for identifying mapped volumes in the external connection destination storages are stored in the external connection destination storage VOL ID 624. Pieces of information representing the connection states of external connection are stored in the connection state (connected/disconnected) 625.

FIG. 7 is a figure for explaining the backup route management table 700. As columns storing information (values), the backup route management table 700 includes a backup route ID 701, a backup target name 702, a route number 703, and a route configuration 704. The backup route management table 700 has stored therein, as mutually-associated pieces of information (records) of each row, information corresponding to each column related to an acquisition route of backup data (a backup image) (called a backup route, a route, or a path, in some cases).

Specifically speaking, IDs for identifying backup routes are stored in the backup route ID 701. Names of backup-target productions are stored in the backup target name 702. Identification numbers for identifying (make distinctions between) backup routes corresponding to common backup targets are stored in the route number 703. Pieces of information representing backup-route configurations (e.g., IDs of volumes that are used to configure the backup routes) are stored in the route configuration 704.

Note that the backup route management table 700 is created by the management server 100 on the basis of various types of tables (FIG. 5A to FIG. 6C) that the management server 100 has acquired from the first storage 10 and the second storage 20.

FIG. 8 is a figure for explaining the backup route execution result management table 800. As columns storing information (values), the backup route execution result management table 800 includes a backup route ID 801, a backup target name 802, a route number 803, an execution date/time 804, and an MF-side backup status 805. The backup route execution result management table 800 has stored in, as mutually-associated pieces of information (records) of each row, information corresponding to each column related to a result of execution of backup storage through a backup route. Specifically speaking, information similar to the information stored in the backup route ID 701, backup target name 702, and route number 703 described already is stored in the backup route ID 801, the backup target name 802, and the route number 803, respectively. Backup-storage execution dates/times are stored in the execution date/time 804. Information representing backup-storage execution results (statuses) is stored in the MF-side backup status 805.

FIG. 9A is a figure for explaining the first backup data management table 900. As columns storing information (values), the first backup data management table 900 includes a backup volume ID 901, a copy number 902, a backup date/time 903, and an expiration date/time 904. The first backup data management table 900 has stored therein, as mutually-associated pieces of information (records) of each row, information corresponding to each column related to a backup image of the first backup volume 31. Specifically speaking, IDs for identifying backup volumes are stored in the backup volume ID 901. Copy numbers associated with the backup images are stored in the copy number 902. Acquisition times of the backup images are stored in the backup date/time 903. Expiration dates/times of the backup images are stored in the expiration date/time 904.

FIG. 9B is a figure for explaining the second backup data management table 910. As columns storing information (values), the second backup data management table 910 includes a backup volume ID 911, a copy number 912, a backup date/time 913, and an expiration date/time 914. The second backup data management table 910 has stored therein, as mutually-associated pieces of information (records) of each row, information corresponding to each column related to a backup image of the second backup volume 32. Specifically speaking, information similar to the information stored in the backup volume ID 901, copy number 902, backup date/time 903, and expiration date/time 904 described already is stored in the backup volume ID 911, the copy number 912, the backup date/time 913, and the expiration date/time 914, respectively.

FIG. 10 is a figure for explaining the backup generation information management table 1000. As columns storing information (values), the backup generation information management table 1000 includes a backup route ID 1001, a copy number 1002, a backup date/time 1003, and an expiration date/time 1004. The backup generation information management table 1000 has stored therein, as mutually-associated pieces of information (records) of each row, information corresponding to each column related to backup data.

Specifically speaking, IDs for identifying backup routes are stored in the backup route ID 1001.

Information similar to the information stored in the copy number 902, backup date/time 903, and expiration date/time 904 described already is stored in the copy number 1002, the backup date/time 1003, and the expiration date/time 1004, respectively.

FIG. 11 is a figure for explaining the third external connection mapping table 1100. As columns storing information (values), the third external connection mapping table 1100 includes a backup volume ID 1101, an access VOL ID 1102, and a use 1103. The third external connection mapping table 1100 has stored therein, as mutually-associated pieces of information (records) of each row, information corresponding to each column related to mapping of a volume. Specifically speaking, IDs for identifying backup volumes are stored in the backup volume ID 1101. IDs for identifying access volumes are stored in the access VOL ID 1102. Information representing uses of the access volumes identified by the access VOL ID 1102, for example, information regarding uses such as verification for data verification, restoration of backup images, or further backup storage of backup images, is stored in the use 1103.

FIG. 12 is a figure for explaining the linkage table 1200. As columns storing information (values), the linkage table 1200 includes a backup volume ID 1201, an access VOL ID 1202, and a linked copy number 1203. The linkage table 1200 has stored therein, as mutually-associated pieces of information (records) of each row, information corresponding to each column related to linkage (association) between a copy number and an access volume.

Specifically speaking, information similar to the information stored in the backup volume ID 1101 and the access VOL ID 1102 is stored in the backup volume ID 1201 and the access VOL ID 1202, respectively.

Copy numbers linked with the access volumes 35 are stored in the linked copy number 1203.

FIG. 13 is a figure for explaining the fourth external connection mapping table 1300. As columns storing information (values), the fourth external connection mapping table 1300 includes an external connection source storage virtual VOL ID 1301, an external connection destination storage ID 1302, an external connection destination storage access VOL ID 1303, and a connection state (connected/disconnected) 1304. The fourth external connection mapping table 1300 has stored therein, as mutually-associated pieces of information (records) of each row, information corresponding to each column related to mapping of a volume. Specifically speaking, IDs for identifying external connection source virtual volumes are stored in the external connection source storage virtual VOL ID 1301. IDs for identifying external connection destination storages are stored in the external connection destination storage ID 1302. IDs for identifying access volumes of the external connection destination storages are stored in the external connection destination storage access VOL ID 1303. Pieces of information representing the connection states are stored in the connection state (connected/disconnected) 1304.

### Overview

Hereinbelow, an overview of the backup system according to the first embodiment is explained. First, a basic operation (a backup basic operation and data verification) of the backup system is explained.

### Backup Basic Operation

The first storage 10 refers to the first True Copy management table 510, copies, by True Copy, data written in the production volume 11, to the replica volume 21 of the second storage 20, and keeps the production volume 11 and the replica volume 21 synchronized.

When a set backup acquisition date/time comes, the first storage 10 refers to the first volume copy management table 500 and the first external connection mapping table 520, creates a copy of data of the production volume 11 by Shadow Image (SI) and the external connection function, stores the copy of the data in the first backup volume 31, and updates the first backup volume 31.

The BP storage 30 creates a backup image by evacuating, by Thin Image, a portion of the first backup volume 31 that has been updated from the pre-updated first backup volume 31, to a pool volume that is used to configure the data protection area 33, gives the backup image a copy number of an available pair, and stores the backup image in the data protection area 33.

Similarly, when a set backup acquisition date/time comes (i.e., at the same date/time as the backup acquisition date/time described above), the second storage 20 refers to the second volume copy management table 600 and the second external connection mapping table 620, creates a copy of data of the replica volume 21 by Shadow Image (SI) and the external connection function, stores the copy of the data in the second backup volume 32, and updates the second backup volume 32.

The BP storage 30 creates a backup image by evacuating, by Thin Image, a portion of the second backup volume 32 that has been updated from the pre-updated second backup volume 32, to a pool volume that is used to configure the data protection area 33, gives the backup image a copy number of an available pair, and stores the backup image in the data protection area 33.

As a result, in the backup system, a backup image (hereinafter, called a “first route BP image”) is acquired through a first backup route to the production volume 11 of the first storage 10, the first backup route being configured by using the virtual volume 12 and the first backup volume 31 of the BP storage 30, and the acquired first route BP image is stored in the data protection area 33.

In the backup system, a backup image (hereinafter, called a “second route BP image”) is acquired through a second backup route to the production volume 11 of the first storage 10, the second backup route being configured by using the replica volume 21 of the second storage 20, the virtual volume 22 and the second backup volume 32 of the BP storage, and the acquired second route BP image is stored in the data protection area 33.

Here, the first route BP image and the second route BP image that have been acquired at the same backup acquisition date/time are pieces of backup data of the production volume 11 acquired at the same backup acquisition date/time. That is, in this backup system, backup data is duplicated through two backup routes (backup acquisition routes). Further, in this backup system, one of the duplicated pieces of backup data (backup images) is stored in the data protection area 33. As a result, by using the capacity of the data protection area 33 efficiently, a greater number of generations of backup images can be stored for the data protection area 33 with particular capacity.

The backup basic operation targeted at the production PD1 (production volume 11) has been described above. Note that, as for a production PD2 also, backup data targeted at the production PD2 can be acquired, and stored in the data protection area 33, by a similar backup basic operation. Illustrations of a volume and a virtual volume of the first storage 10 equivalent to the production volume 11 and the virtual volume 12 used in this case, a volume and a virtual volume of the second storage 20 equivalent to the replica volume 21 and the virtual volume 22 used in this case, and backup volumes of the BP storage 30 equivalent to the first backup volume 31 and the second backup volume 32 are omitted in FIG. 1.

### <Data Verification>

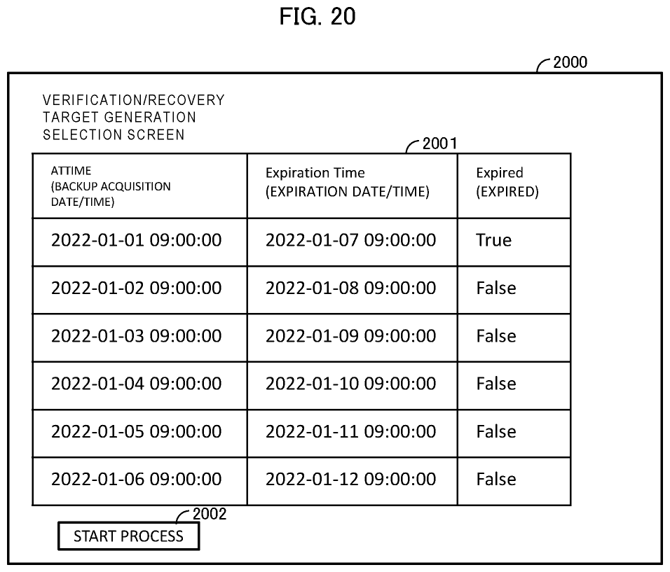

When a generation of a backup is selected by user manipulation on a GUI screen 2000 (FIG. 20), the verifying server 200 causes the management server 100 to transmit, to the BP storage 30, a restoration instruction specifying a backup date/time of the selected generation, a backup target name, and an access volume. Note that the GUI screen 2000 (FIG. 20) is described in detail later.

Upon reception of the restoration instruction from the management server 100, the BP storage 30 refers to the first backup data management table 900 and the second backup data management table 910 to identify a copy number and an ID of a backup volume on the basis of the specified backup date/time.

The BP storage 30 performs mapping of a backup image identified by the copy number and the ID of the backup volume to the specified access volume. Note that the BP storage 30 updates the linkage table 1200 by adding the copy number and the access volume ID to the linkage table 1200.

For example, in a case where the acquired copy number is “#5,” the ID of the backup volume is “32,” and the ID of the specified access volume is “35,” the BP storage 30 performs mapping of the backup image 32b identified by the copy number “#5” and the backup volume ID “32” to the access volume 35 (refer to FIG. 1).

Note that the BP storage 30 may refer to the backup generation information management table 1000, and perform mapping of a backup image to the specified access volume on the basis of the specified backup date/time in the following manner.

That is, upon reception of the restoration instruction from the management server 100, the BP storage 30 refers to the backup generation information management table 1000, and identifies a copy number and a backup route ID on the basis of the specified backup date/time.

The BP storage 30 performs mapping of a backup image identified by the copy number and the backup route ID to the specified access volume.

For example, in a case where the acquired copy number is “#5,” the backup route ID is “2,” and the ID of the specified access volume is “35,” the BP storage 30 performs mapping of the backup image 32b identified by the copy number “#5” and the backup route ID “2” to the access volume 35 (refer to FIG. 1). In this case, the linkage table 1200 additionally has a column for backup route IDs, and has stored therein, in the column, IDs for identifying backup routes corresponding to backup volumes.

When the second storage 20 receives an external connection instruction from the verifying server 200, mapping is performed in the fourth external connection mapping table 1300 in the second storage 20 treating the access volume 35 of the BP storage 30 as an external connection destination access volume, and the virtual volume 23 of the second storage 20 as an external connection source virtual volume, and sets the connection state to “connected.”

As a result, the verifying server 200 can perform data verification by referring to data of the virtual volume 23. That is, by accessing the virtual volume 23 to which the access volume 35 is mapped, the verifying server 200 can read out and verify data that is used to configure a backup image of a particular generation in the data protection area 33. Note that, as necessary, data of the virtual volume 23 may be copied to a backup target (the production PD1 in FIG. 1), and the data may be restored.

Note that, when the second storage 20 receives an external connection cancellation instruction from the verifying server 200 thereafter, the second storage 20 unlinks (disconnects) the relation between the virtual volume 23 and the access volume 35 of the BP storage 30. The BP storage 30 cancels the mapping of the access volume 35 and the backup image 32b in accordance with an instruction from the management server 100. Note that the BP storage 30 updates the linkage table 1200 by deleting the relevant row from the linkage table 1200.

In the manner described above, the verifying server 200 can perform data verification by referring to data of the virtual volume 23. Note that the data of the virtual volume 23 may be not necessarily used for data verification, but may be used for other uses.

### <Overview of Operation Performed by Backup System>

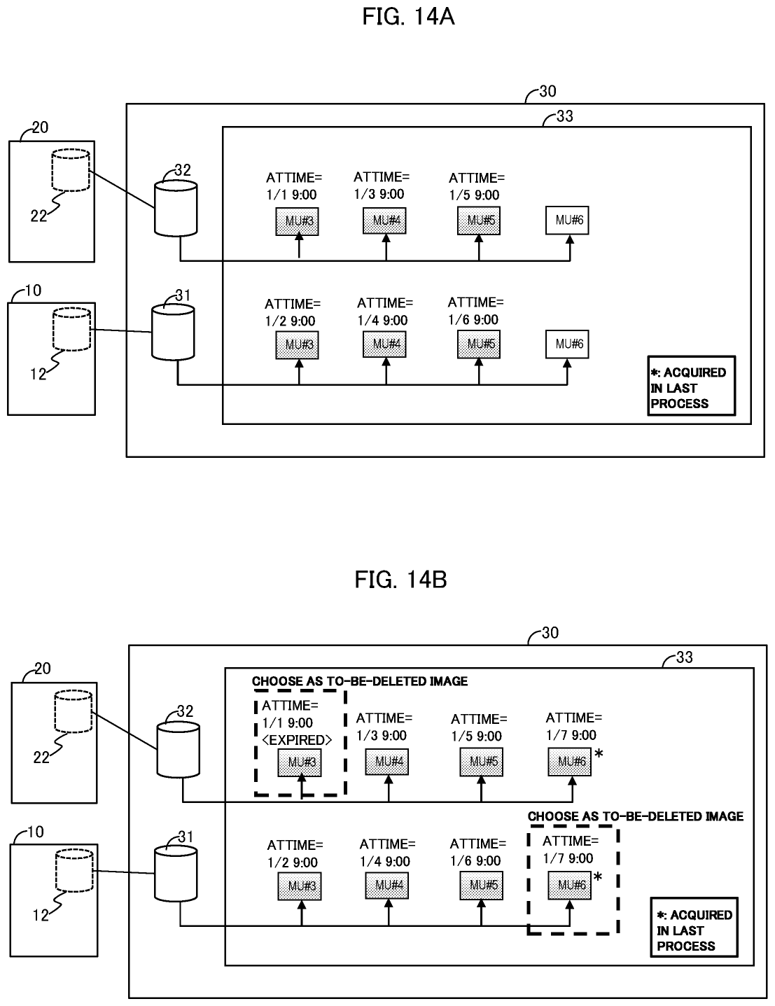

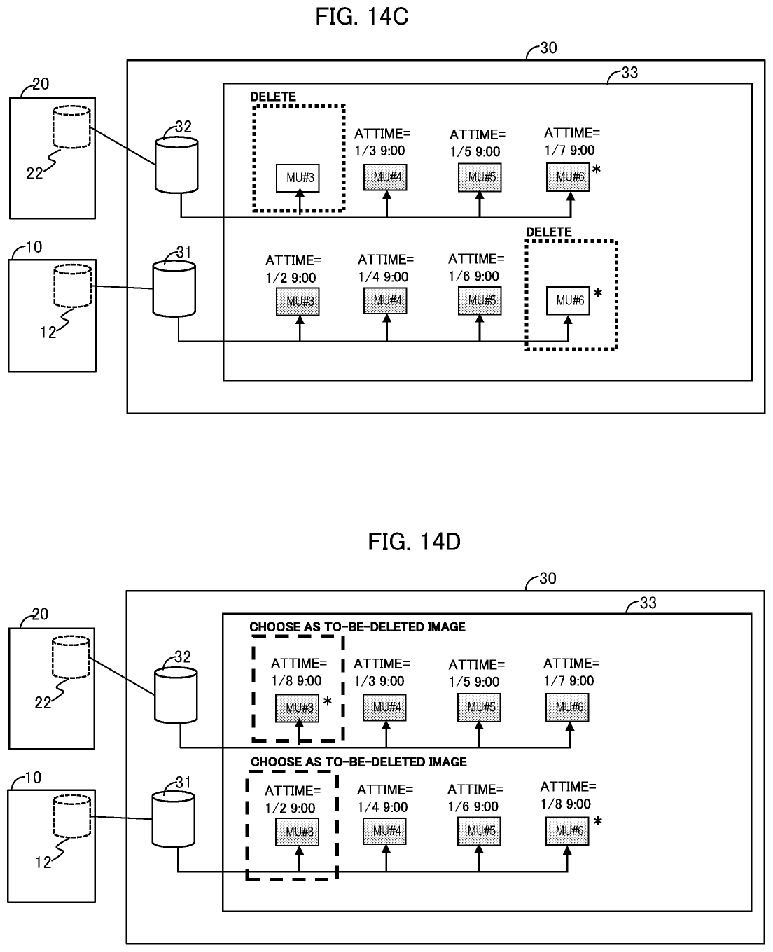

An overview of an operation performed by the backup system (optimization of storage of backup data in the data protection area 33) is explained. FIG. 14A to FIG. 14D are figures for explaining the overview of the operation performed by the backup system. Note that, in the present example, the BP storage 30 is configured to acquire a backup image once a day at a predetermined time (9:00 in the present example), and store the backup image for six days. The BP storage 30 retains, in the data protection area 33, backup images of six generations whose acquisition dates/times are different.

In the initial state, the BP storage 30 manages backup images on the basis of copy numbers of six generations for data retention and copy numbers of two generations necessary for other data storage processes such that the first backup volume 31 and the second backup volume 32 have predetermined numbers of pairs (backup images), respectively.

For example, in the initial state, the BP storage 30 manages backup images by using copy numbers of four generations of the first backup volume 31 and copy numbers of four generations of the second backup volume 32.

First, it is assumed in the following case to be explained that both a first route BP image and a second route BP image has been able to be acquired (backup storage has been successful).

The data protection area 33 in FIG. 14A represents a state where first route BP images of three generations are stored and second route BP images of three generations are stored. In the state depicted in FIG. 14A, the copy number #6 of the first backup volume 31 is an available pair, and the copy number #6 of the second backup volume 32 is an available pair. When a set backup acquisition date/time (9:00 on January 7) comes in the state depicted in FIG. 14A, the BP storage 30 can acquire a first route BP image, gives the first route BP image the available copy number #6, and stores the first route BP image in the data protection area 33, by the backup basic operation described above. The BP storage 30 can acquire a second route BP image, gives the second route BP image the available copy number #6, and stores the second route BP image in the data protection area 33, by the backup basic operation described above.

As a result, the state of the BP storage 30 is now a state depicted in FIG. 14B. In the data protection area 33 depicted in FIG. 14B, the first route BP image to which the copy number #6 is given and the second route BP image to which the copy number #6 is given are acquired by the last backup acquisition process.

Note that, in the following explanation, a first route BP image to which a copy number #N is given is called a first route BP image (#N) for convenience in some cases. A second route BP image to which the copy number #N is given is called a second route BP image (#N) for convenience in some cases.

The BP storage 30 creates available pairs in accordance with the following first storage optimization rules (1) to (3).
(1) The oldest generation of an expired backup image is deleted.
(2) Either of backup images acquired in the last process is deleted such that each of the first backup volume 31 and the second backup volume 32 has at least one or more available pairs.
(3) In a case where a difference is generated between the numbers of first route BP images and second route BP images stored in the data protection area 33 in (2), either of the backup images acquired in the last process is deleted such that the difference between the numbers decreases (is removed).

Accordingly, the BP storage 30 chooses an expired second route BP image (#3) as a to-be-deleted image, chooses the first route BP image (#6) acquired in the last process, as a to-be-deleted image, and deletes them.

As a result, the state of the BP storage 30 is now a state depicted in FIG. 14C. In this state, the copy number #6 of the first backup volume 31 is an available pair, and the copy number #3 of the second backup volume 32 is an available pair. When a set backup acquisition date/time (9:00 on January 8) comes in the state depicted in FIG. 14C, the BP storage 30 can acquire a first route BP image, gives the first route BP image the available copy number #6, and stores the first route BP image in the data protection area 33, by the backup basic operation described above. The BP storage 30 can acquire a second route BP image, gives the second route BP image the available copy number #3, and stores the second route BP image in the data protection area 33, by the backup basic operation described above. As a result, the state of the BP storage 30 is now a state depicted in FIG. 14D. In the state depicted in FIG. 14D, the BP storage 30 chooses an expired first route BP image (#3) as a to-be-deleted image, chooses the second route BP image (#3) acquired in the last process, as a to-be-deleted image, and deletes them. Thereafter, similar operations are performed. Note that the BP storage 30 does not actively store, in the data protection area 33, first route BP images and second route BP images such that generations of the first route BP images and the second route BP images alternate, unlike a second embodiment described in detail later, but generations of the stored first route BP images and second route BP images have become alternating generations. In a case where first route BP images and second route BP images are stored in the data protection area 33 such generations of the first route BP images and the second route BP images alternate, the backups can be verified/recovered at equal intervals over the entire retention period even in a case where a failure has occurred in one backup volume. Note that details of this effect are explained in the second embodiment described later.

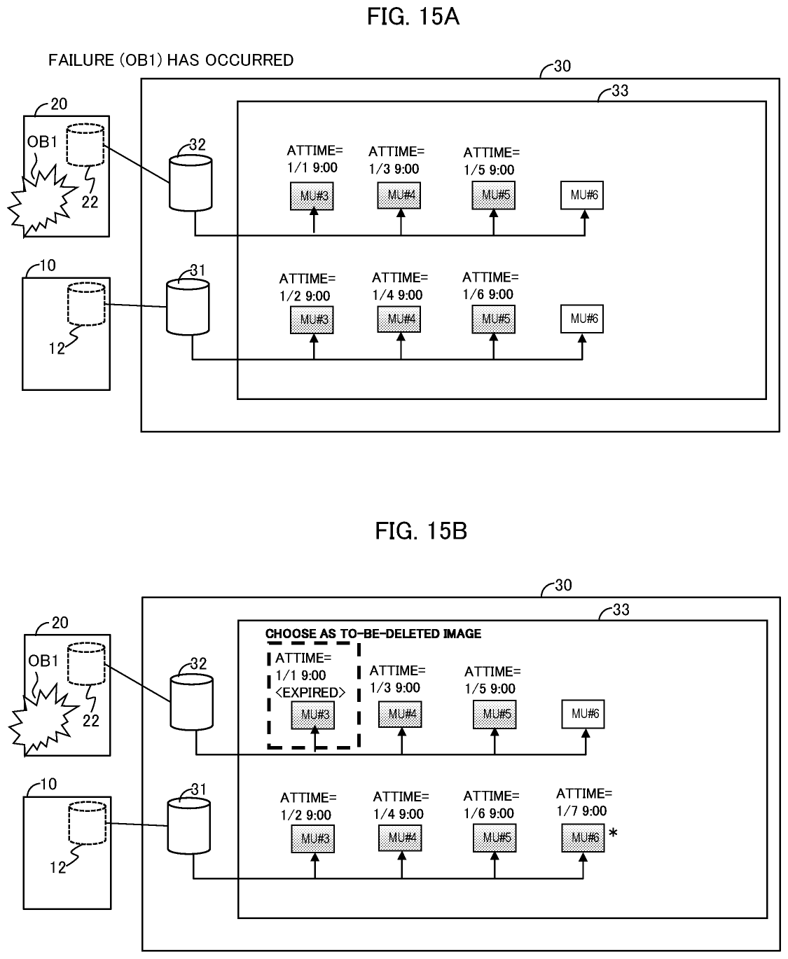

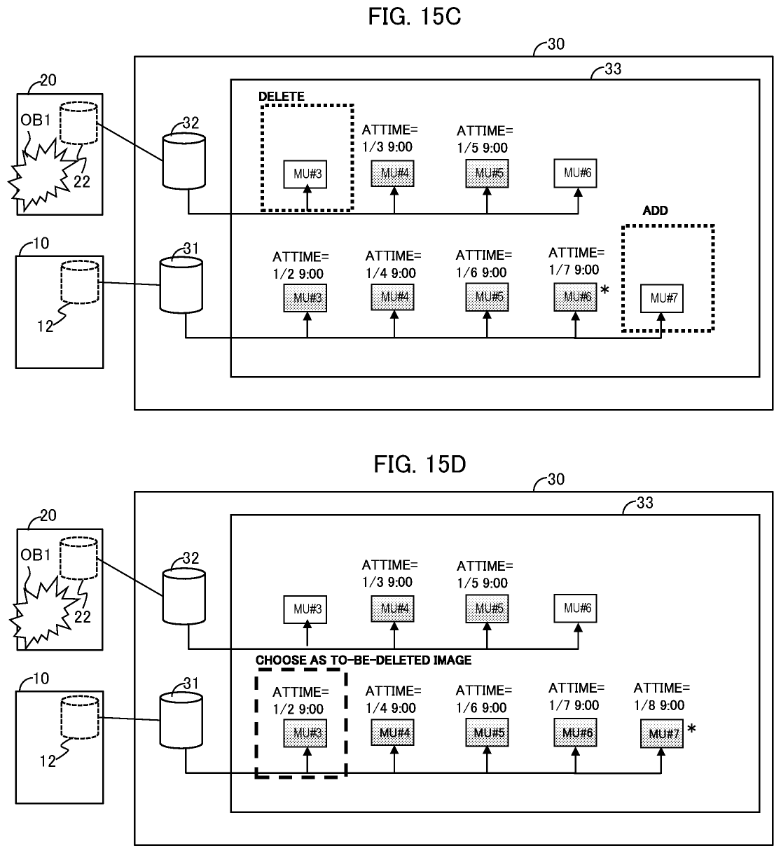

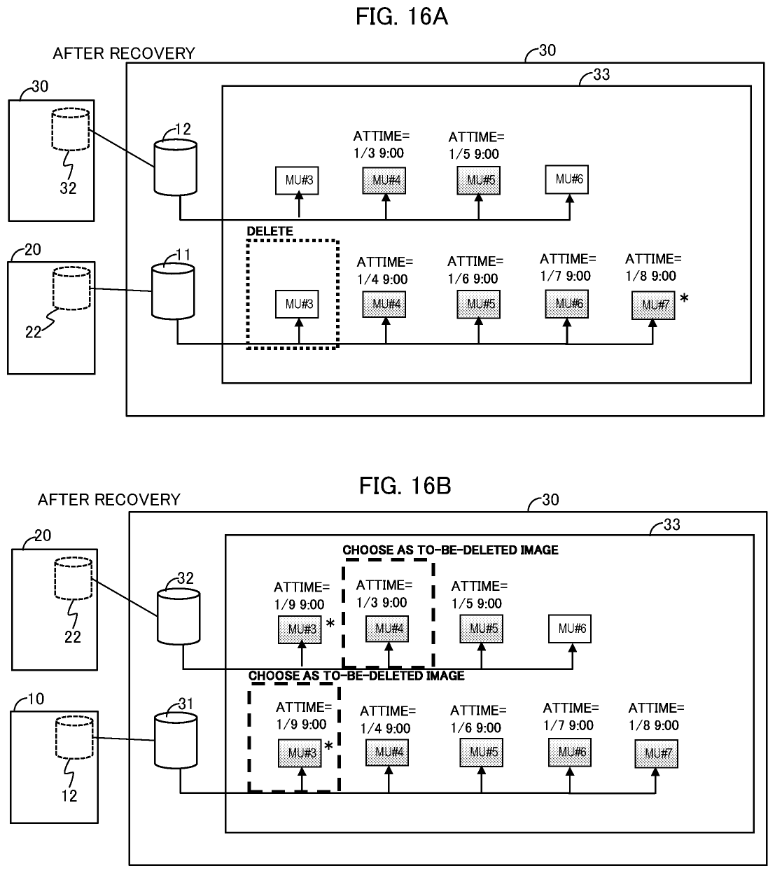

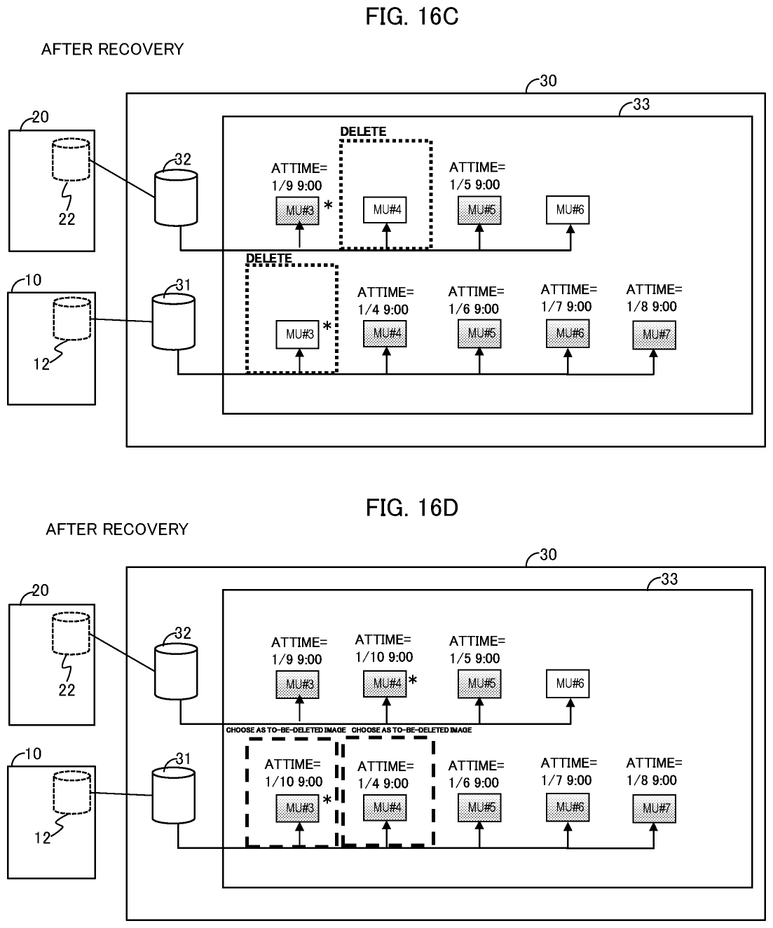

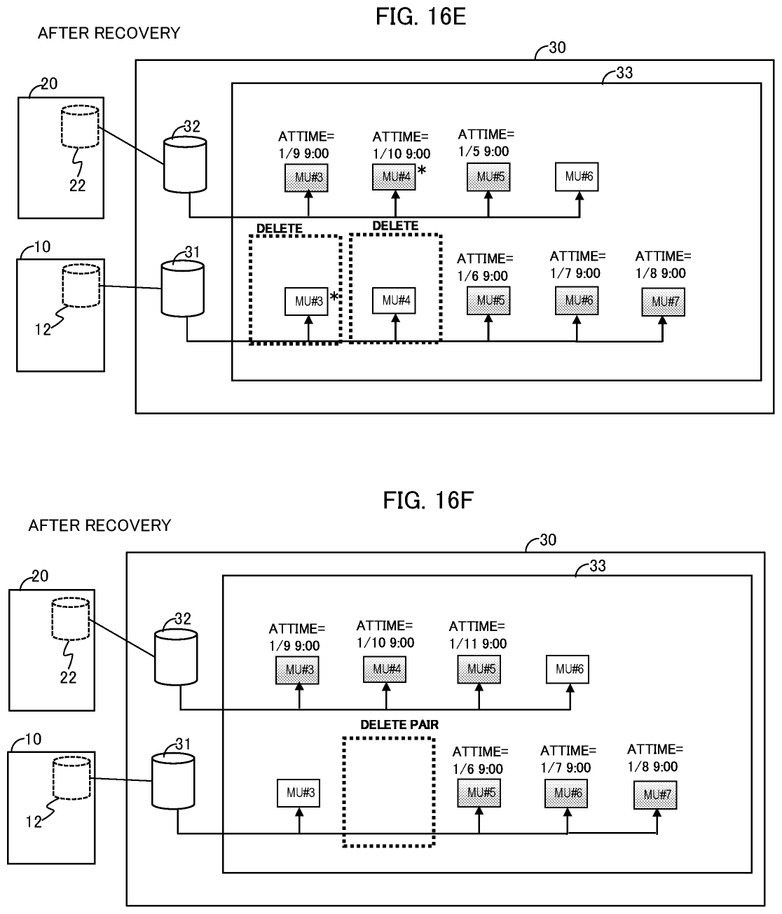

Next, an overview of an operation performed by the backup system in a case where a failure has occurred in one of the backup routes is explained. FIG. 15A to FIG. 15D are figures for explaining the overview of the operation performed by the backup system in a case where the failure has occurred in the one of the backup routes. FIG. 16A to FIG. 16F are figures for explaining an overview of an operation performed by the backup system after failure recovery.

The data protection area 33 in FIG. 15A represents a state where first route BP backup images of three generations are stored and second route BP images of three generations are stored. In a case where a set backup acquisition date/time (9:00 on January 7) comes after a failure OB1 has occurred in the second storage 20 after 9:00 on January 6 in a state depicted in FIG. 15A, the BP storage 30 can acquire a first route BP image, gives the first route BP image the available copy number #6, and stores the first route BP image in the data protection area 33, by the backup basic operation described above. On the other hand, the BP storage 30 cannot store a second route BP image in the data protection area 33 since the BP storage 30 cannot acquire a second route BP image. As a result, the state of the BP storage 30 is now a state depicted in FIG. 15B.

In a case where only a backup image acquired through one route has been able to be stored in this manner, the BP storage 30 creates an available pair in accordance with the following second storage optimization rules (1) and (2) in the state depicted in FIG. 15B.
(1) The oldest generation of an expired backup image is deleted.
(2) In a case where there is a backup volume not having available pairs even after (1) is performed, a copy number of an available pair is added to the backup volume.

Accordingly, the BP storage 30 chooses an expired second route BP image (#3) as a to-be-deleted image, and deletes it. Further, the BP storage 30 adds a copy number #7 of an available pair. As a result, the state of the BP storage 30 is now a state depicted in FIG. 15C.

When a set backup acquisition date/time (9:00 on January 8) comes in the state depicted in FIG. 15C, the BP storage 30 can acquire a first route BP image, gives the first route BP image the available copy number #7, and stores the first route BP image in the data protection area 33, by the backup basic operation described above. On the other hand, since the failure has not been solved in the second backup route yet, a second route BP image cannot be acquired. As a result, the state of the BP storage 30 is now a state depicted in FIG. 15D.

The BP storage 30 creates an available pair in accordance with the second storage optimization rules (1) and (2) described above in the state depicted in FIG. 15D. Accordingly, the BP storage 30 chooses an expired first route BP image (#3) as a to-be-deleted image, and deletes it. Note that, in this case, a copy number of an available pair is not added since there are no backup volumes not having available pairs even if (1) is performed.

As a result, the state of the BP storage 30 is now a state depicted in FIG. 16A. When there has been recovery from the failure and then a set backup acquisition date/time (9:00 on January 9) comes in the state depicted in FIG. 16A, the BP storage 30 can acquire a first route BP image, gives the first route BP image the available copy number #3, and stores the first route BP image in the data protection area 33, by the backup basic operation described above. The BP storage 30 can acquire a second route BP image, gives the second route BP image the available copy number #3, and stores the second route BP image in the data protection area 33, by the backup basic operation described above. As a result, the state of the BP storage 30 is now a state depicted in FIG. 16B.

In the state depicted in FIG. 16B, in accordance with the first storage optimization rules (1) to (3) described already, the BP storage 30 chooses an expired second route BP image (#4) as a to-be-deleted image, chooses the first route BP image (#3) acquired in the last process, as a to-be-deleted image, and deletes them. As a result, the state of the BP storage 30 is now a state depicted in FIG. 16C. When a set backup acquisition date/time (9:00 on January 10) comes in the state depicted in FIG. 16C, the BP storage 30 can acquire a first route BP image, gives the first route BP image the available copy number #3, and stores the first route BP image in the data protection area 33, by the backup basic operation described above. The BP storage 30 can acquire a second route BP image, gives the second route BP image the available copy number #4, and stores the second route BP image in the data protection area 33, by the backup basic operation described above.

As a result, the state of the BP storage 30 is now a state depicted in FIG. 16D. In the state depicted in FIG. 16D, in accordance with the first storage optimization rules (1) to (3) described already, the BP storage 30 chooses an expired first route BP image (#4) as a to-be-deleted image, chooses the first route BP image (#3) acquired in the last process, as a to-be-deleted image, and deletes them.

As a result, the state of the BP storage 30 is now a state depicted in FIG. 16E. In the state depicted in FIG. 16E, the copy number #3 and the copy number #4 of the first backup volume 31 are available pairs, and the copy number #6 of the second backup volume 32 is an available pair. In this manner, when there are two available pairs of the one first backup volume 31 after the recovery, the BP storage 30 deletes one of the available pairs (i.e., deletes one of the copy numbers that have become unnecessary). As a result, the state of the BP storage 30 becomes a state in FIG. 16F, and an unnecessary available pair can be deleted.

Note that, since removal of the difference between the numbers of pairs of first route BP images and second route BP images is prioritized after the recovery in the first embodiment, there can be a case where generations of the stored first route BP images and generations of the stored second route BP images do not alternate as represented by the second route BP image (#3) and the second route BP image (#4) in FIG. 16E. The first embodiment is different from the second embodiment, which will be described later, in this regard.

### Specific Operation

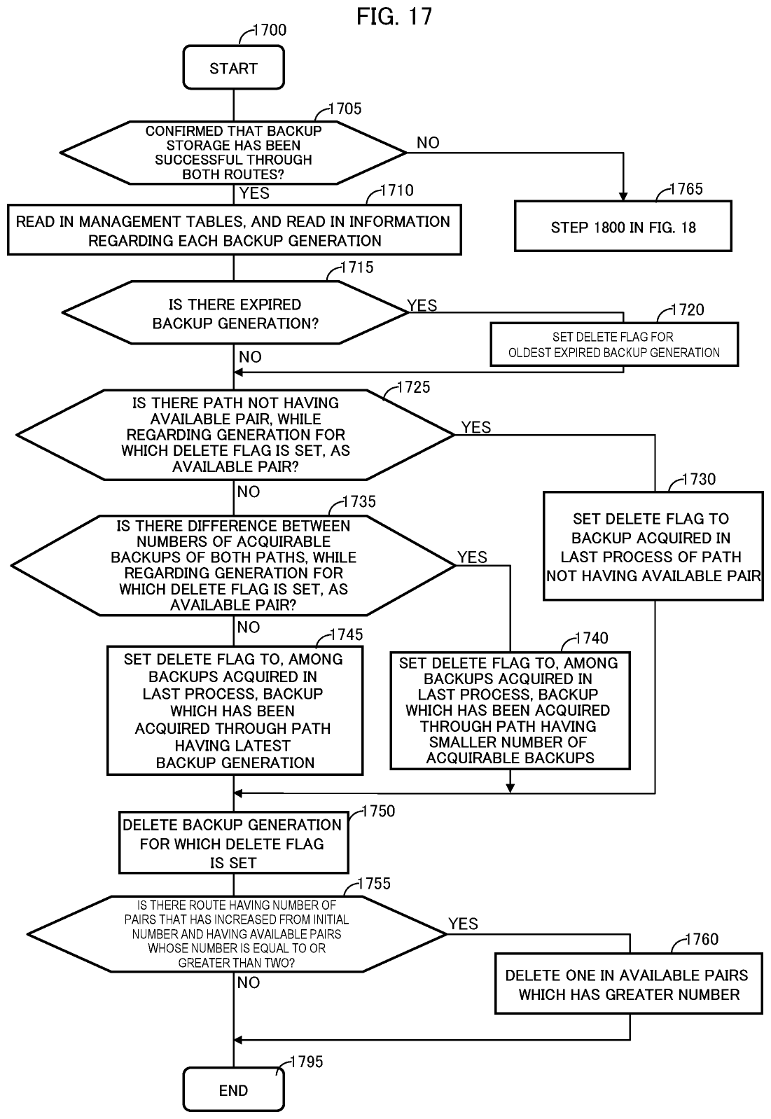

A specific operation performed by the backup system is explained. FIG. 17 is a flowchart depicting a processing procedure executed by the CPU 130 of the management server 100. The CPU 130 starts the process from Step 1700 in FIG. 17, proceeds to Step 1705, and assesses whether or not it has been able to be confirmed that backup storage has been successful through both the routes, by referring to the backup route execution result management table 800.

In a case where it has been able to be confirmed that backup storage has been successful through both the routes, the CPU 130 determines that the result of the assessment in Step 1705 is “YES,” proceeds to Step 1710, reads in the first management information 112 (first backup data management table 900 and second backup data management table 910), and reads in information regarding each backup generation (each generation of a backup image).

Thereafter, the CPU 130 proceeds to Step 1715, and assesses whether or not there is an expired backup generation.

In a case where there is an expired backup generation, the CPU 130 determines that the result of the assessment in Step 1715 is “YES,” proceeds to Step 1720, sets a delete flag for the oldest expired backup generation, and then proceeds to Step 1725. In a case where there are no expired backup generations, the CPU 130 determines that the result of the assessment in Step 1715 is “NO,” and proceeds directly to Step 1725.

When the CPU 130 proceeds to Step 1725, it assesses whether or not there is a backup path not having an available pair (i.e., whether or not there are available copy numbers of the backup volumes), while regarding a generation for which a delete flag is set (a copy number of the generation), as an available pair.

In a case where there is a backup path not having an available pair, the CPU 130 determines that the result of the assessment in Step 1725 is “YES,” proceeds to Step 1730, sets a delete flag to a backup (backup image) acquired in the last process through the path not having an available pair, and then proceeds to Step 1750.

In a case where there are no backup paths not having available pairs, the CPU 130 determines that the result of the assessment in Step 1725 is “NO,” proceeds to Step 1735, and assess whether or not there is a difference in the numbers of acquirable backups of both the paths (backup routes) (i.e., the numbers of copy numbers of available pair), while regarding a generation for which a delete flag is set (a copy number of the generation), as an available pair.

In a case where there is a difference in the numbers of acquirable backups of both the paths, the CPU 130 determines that the result of the assessment in Step 1735 is “YES,” proceeds to Step 1740, sets a delete flag to, among backups (backup images) acquired in the last process, a backup acquired through a path having a smaller number of acquirable backups, and then proceeds to Step 1750.

In a case where there is no difference in the numbers of acquirable backups of both the paths, the CPU 130 determines that the result of the assessment in Step 1735 is “NO,” proceeds to Step 1745, sets a delete flag to, among backups (backup images) acquired in the last process, a backup acquired through a path having the latest backup generation, and then proceeds to Step 1750.

When the CPU 130 proceeds to Step 1750, the CPU 130 commands the BP storage 30 to delete a backup generation for which a delete flag is set. Upon reception of the command, the BP storage 30 deletes a backup generation for which a delete flag is set.

Thereafter, the CPU 130 proceeds to Step 1755, and assesses whether or not there is a route having the number of pairs that has increased from the initial number and having available pairs whose number is equal to or greater than two.

In a case where there is a route having the number of pairs that has increased from the initial number and having available pairs whose number is equal to or greater than two, an available pair of the route is unnecessary. Accordingly, in this case, the CPU 130 determines that the result of the assessment in Step 1755 is “YES,” proceeds to Step 1760, and deletes one in the available pairs which has the greater number.

In a case where there are no routes having the numbers of pairs that has increased from the initial numbers and having available pairs whose numbers are equal to or greater than two, the CPU 130 determines that the result of the assessment in Step 1755 is “NO,” proceeds to Step 1795, and temporarily ends the present processing flow.

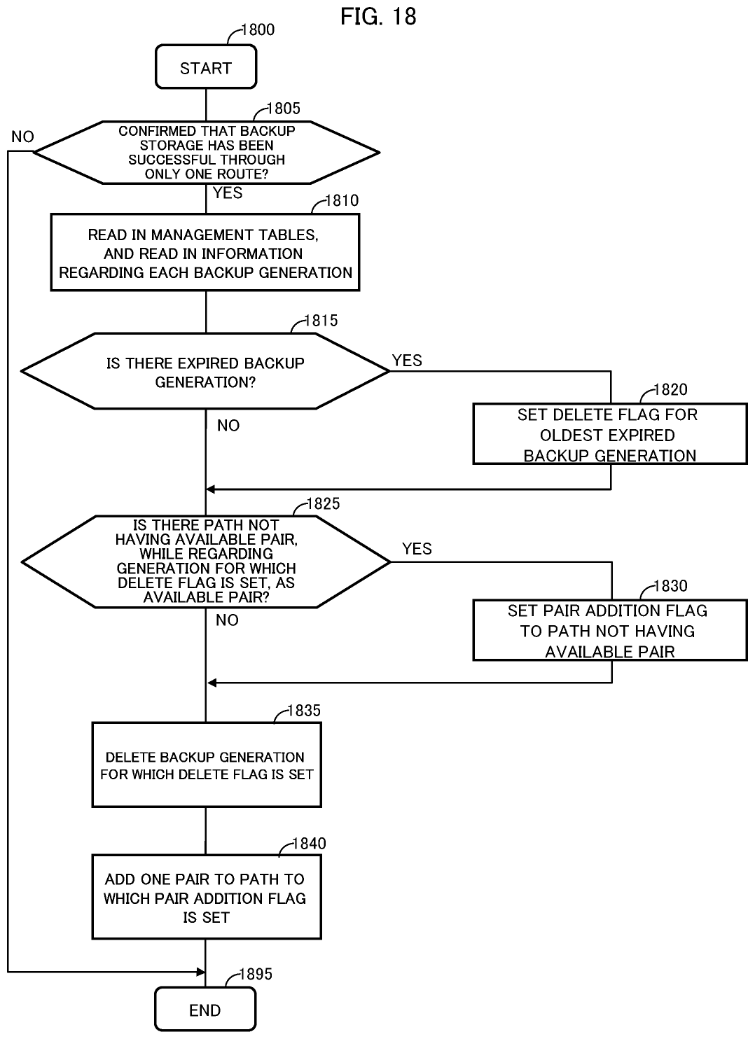

Note that, in a case where it has not been able to be confirmed in the process in Step 1705 that backup storage through at least either of the routes has not been successful, the CPU 130 determines that the result of the assessment in Step 1705 is “NO,” and proceeds to Step 1800 in a processing procedure in FIG. 18 through Step 1765.

FIG. 18 is a flowchart depicting a processing procedure executed by the CPU 130 of the management server 100. When the CPU 130 determines that the result of the assessment in Step 1705 in FIG. 17 is “NO” and proceeds to Step 1800, the CPU 130 starts the process, proceeds to Step 1805, and assesses whether or not it has been able to be confirmed that backup storage through only one route has been successful.

In a case where it has not been able to be confirmed that backup storage through only one route has been successful, this means that backup storage through none of the routes has been successful. Accordingly, in this case, the CPU 130 determines that the result of the assessment in Step 1805 is “NO,” proceeds to Step 1895, and temporarily ends the present processing flow.

In a case where it has been able to be confirmed that backup storage through only one route has been successful, the CPU 130 reads in the first management information 112 (first backup data management table 900 and second backup data management table 910), and reads in information regarding a generation of each backup (backup image).

Thereafter, the CPU 130 proceeds to Step 1815, and assesses whether or not there is an expired backup generation.

In a case where there is an expired backup generation, the CPU 130 determines that the result of the assessment in Step 1815 is “YES,” proceeds to Step 1820, sets a delete flag for the oldest expired backup generation, and then proceeds to Step 1825. In a case where there are no expired backup generations, the CPU 130 determines that the result of the assessment in Step 1815 is “NO,” and proceeds directly to Step 1825.

When the CPU 130 proceeds to Step 1825, the CPU 130 assesses whether or not there is a backup path not having an available pair (i.e., whether or not there are available copy numbers of the backup volumes), while regarding a generation for which a delete flag is set (a copy number of the generation), as an available pair.

In a case where there is a backup path not having an available pair, the CPU 130 determines that the result of the assessment in Step 1825 is “YES,” proceeds to Step 1830, sets a pair addition flag to a backup path not having an available pair, and then proceeds to Step 1835. In a case where there are no backup paths not having available pairs, the CPU 130 determines that the result of the assessment in Step 1835 is “NO,” and proceeds directly to Step 1825.

When the CPU 130 proceeds to Step 1835, the CPU 130 commands the BP storage 30 to delete a backup generation for which a delete flag is set. Upon reception of the command, the BP storage 30 deletes a backup generation for which a delete flag is set.

Thereafter, the CPU 130 proceeds to Step 1840, and commands the BP storage 30 to add one pair (available pair (copy number)) to a path to which a pair addition flag is set. Upon reception of the command, the BP storage 30 adds one pair (available pair (copy number)) to a path to which a pair addition flag is set. Thereafter, the CPU 130 proceeds to Step 1895, and temporarily ends the present processing flow.

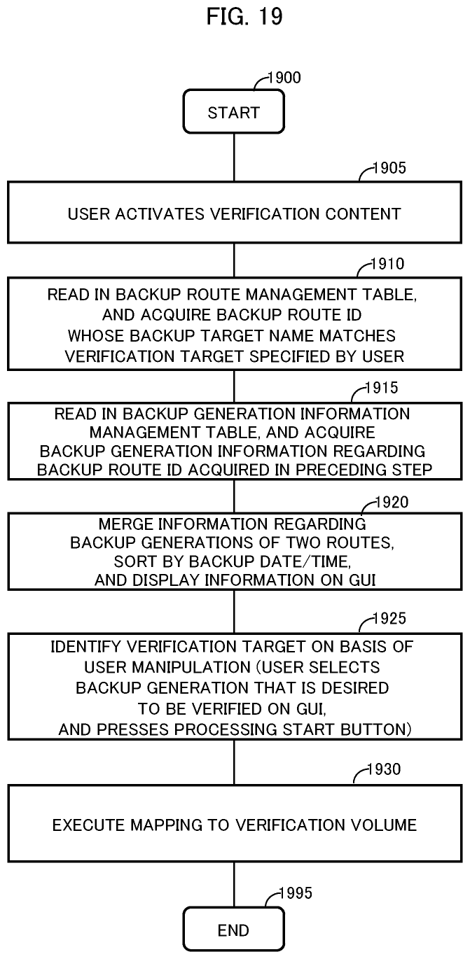

FIG. 19 is a flowchart depicting a processing procedure executed by the CPU 230 of the verifying server 200. The CPU 230 starts the process from Step 1900, executes processes in Step 1905 to Step 1930 described below in order, then proceeds to Step 1995, and temporarily ends the present processing flow.

Step 1905: The CPU 230 activates verification content on the basis of user manipulation.

Step 1910: The CPU 230 acquires the backup route management table 700 from the management server 100, reads in the backup route management table 700, and acquires a backup route ID of a backup target name that matches a verification target specified by the user.

Step 1915: The CPU 230 acquires the backup generation information management table 1000 from the management server 100, reads in the backup generation information management table 1000, and acquires information (a backup date/time, an expiration date/time, etc.) regarding a backup generation with the backup route ID acquired in Step 1910.

Step 1920: The CPU 230 merges information regarding backup generations of the two routes, and sorts the information by a backup date/time, and displays the information on the GUI screen of the display 270. FIG. 20 depicts an example of the GUI screen displayed on the display 270 in this process. The GUI screen 2000 includes a backup generation information image 2001 and a processing start button 2002. The backup generation information image 2001 includes acquisition dates/times and expiration dates/times of backups stored in the data protection area 33 and information representing whether or not the backups are expired. The processing start button 2002 is a button configured by using an image.

Step 1925: The CPU 230 identifies a verification target on the basis of user manipulation on the GUI screen 2000. Note that, for example, when the user selects a backup generation (row) that she/he wants to verify on the GUI screen 2000 and presses (manipulates) the processing start button 2002, the selected backup generation is identified as the verification target.

Step 1930: Through the management server 100, the CPU 230 instructs the BP storage 30 to restore the verification-target backup generation identified (selected) in Step 1925. The CPU 230 maps the virtual volume 23 to the access volume 35 linked with a copy number corresponding to the backup image of the generation specified by the BP storage 30. As a result, the verifying server 200 can read out and verify the backup image stored in the data protection area 33, by accessing the virtual volume 23.

### Advantages

As explained above, the backup system according to the first embodiment can improve availability by increasing the number of paths (to two in the present example) through which backup data to be stored in the data protection area 33 is acquired. Further, the backup system according to the first embodiment can efficiently use the capacity of the data protection area 33, and store a greater number of generations of backup data in the data protection area 33 with limited capacity by storing duplicated pieces of backup data in the data protection area 33 such that generations of the duplicated pieces of backup data do not overlap.

### Second Embodiment

The backup system according to the second embodiment of the present invention is explained. In the first embodiment, in a case where acquisition of backup images has been successfully performed without any problems from the initial state, first route BP images and second route BP images to be retained in the data protection area 33 are stored such that generations of the first route BP images and the second route BP images alternate.

On the other hand, in a case where a difference is generated between the numbers of generations of first route BP images and second route BP images retained in the data protection area 33 due to occurrence of an error or the like, either a first route BP image or a second route BP image is stored in the data protection area 33 such that the difference decreases.

This means that, since, in the first embodiment, avoidance of generation of a difference between the numbers of generations of retained backup images (i.e., a difference between the numbers of first route BP images and second route BP images stored in the data protection area 33) is prioritized, for example, first route BP images and second route BP images are undesirably stored in the data protection area 33 in a state where generations of the first route BP images and the second route BP images do not alternate, after a failure has occurred and there has been recovery, for example (e.g., refer to the second route BP image (#3) and the second route BP image (#4) in FIG. 16E).

In contrast to this, the backup system according to the second embodiment is different from the backup system according to the first embodiment only in that, in a case where acquisition of both a first route BP image and a second route BP image has been successful, the backup system according to the second embodiment actively stores, in the data protection area 33, a backup image such that generations of first route BP images and generations of second route BP images alternate (i.e., stores a backup image acquired through a route which is different from a route through which the last backup image has been acquired).

Specifically speaking, in the backup system according to the second embodiment, in a case where acquisition of both a first route BP image and a second route BP image has been successful, the BP storage 30 creates an available pair in accordance with the following third storage optimization rules (1) to (3) instead of the first storage optimization rules (1) to (3) of the first embodiment.
(1) The oldest generation of an expired backup image is deleted.
(2) Either of backup images acquired in the last process is deleted such that each of the first backup volume 31 and the second backup volume 32 has at least one or more available pairs.
(3) A backup image acquired through a route having the latest generation of a backup image in (2) is deleted.

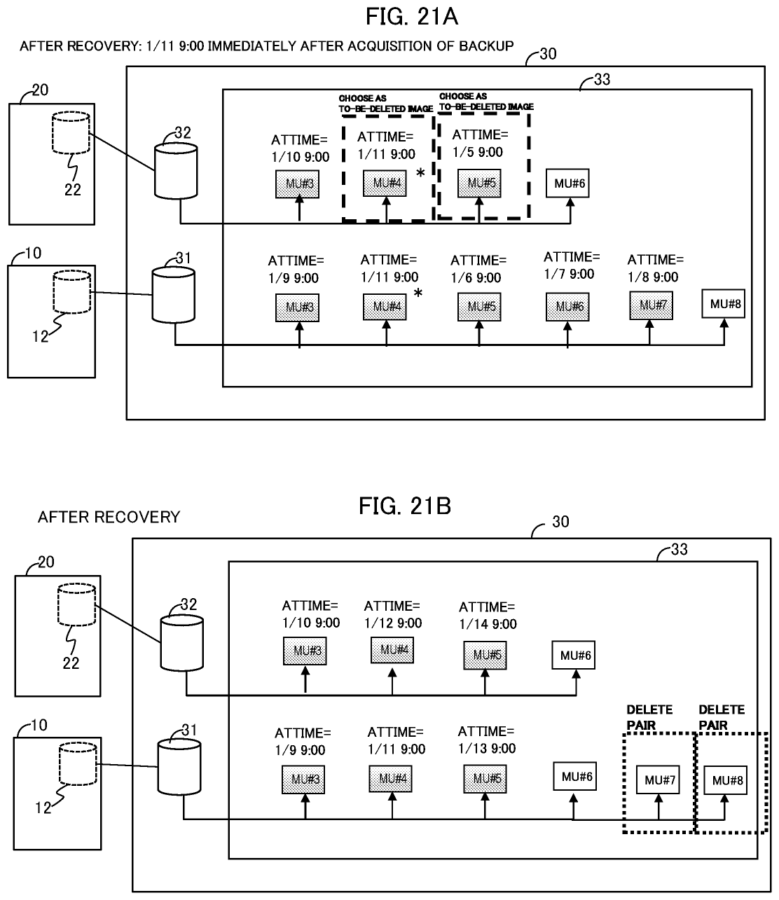

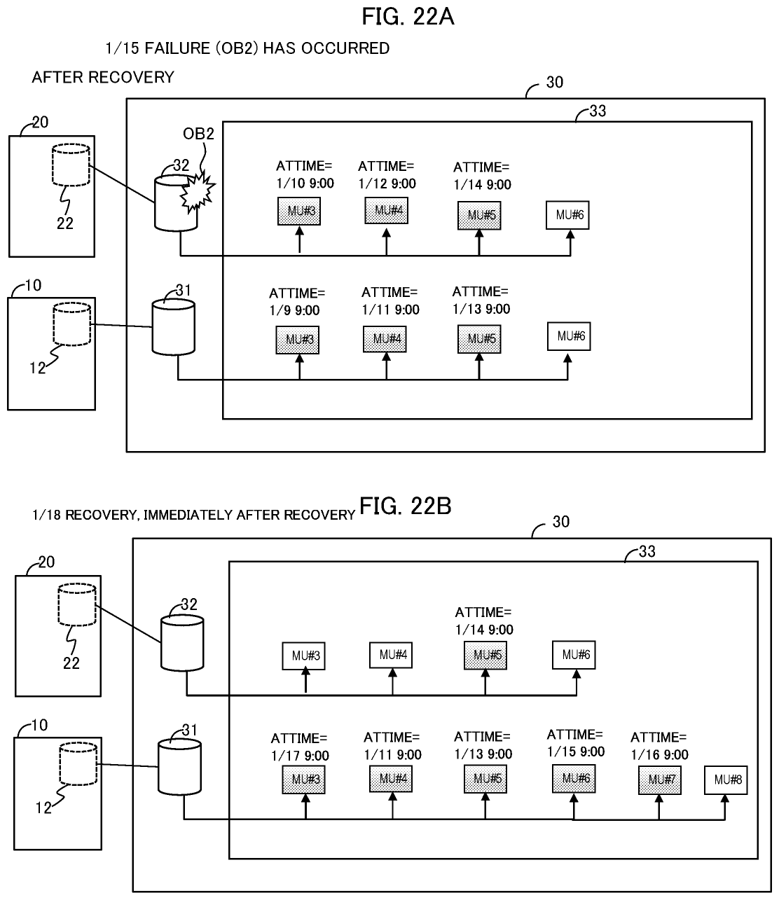

As a result, for example, the backup system according to the second embodiment stores first route BP images and second route BP images in the data protection area 33 such that generations of the first route BP images and the second route BP images alternate even after a failure has occurred and there has been recovery (refer to FIG. 21A and FIG. 22B).

In the technique of the first embodiment, in a case where a difference is generated in the numbers of generations retained in both the routes, backup images are stored consecutively in a volume which retains a smaller number of generations, but there is a risk that there is not data close to a backup acquisition date/time (AT TIME) that is desired to be recovered at a time of occurrence of a failure of a volume. In order to prevent this, in the second embodiment, backup images are actively stored in the data protection area 33 such that generations of the backup images alternate between both the routes in the normal state. As a result, backup data at equal intervals can be verified/recovered over the entire retention period even in a case where a failure has occurred.

Hereinbelow, this difference is mainly explained.

### Overview

FIG. 22A is a figure for explaining an advantage of the backup system according to the second embodiment. The state of the BP storage 30 depicted in FIG. 22A is a state where, after a second route BP image (#6) of a set backup acquisition date/time (9:00 on January 14) is stored in the data protection area 33, a failure (OB2) has occurred in the second backup volume 32 of the BP storage 30 on January 15.

In the state depicted in FIG. 22A, the BP storage 30 chooses the first route BP image (#3) as a to-be-deleted image in accordance with the second storage optimization rules (1) and (2) described already, and adds an available pair to the first backup volume 31. Thereafter, every time a set backup acquisition date/time comes, the BP storage 30 stores, in the data protection area 33, a backup image (i.e., a first route BP image) created through a route not experiencing a failure, in accordance with the second storage optimization rules (1) and (2) described already. FIG. 22B depicts a state of the BP storage 30 in a case where there has been recovery thereafter on January 18.

Since a failure (OB2) has occurred in the second backup volume 32 in a period from the time of occurrence of the failure (January 15) to recovery of the failure (January 18) in such an example depicted in FIG. 22A and FIG. 22B, restoration of backup data (backup image) cannot be performed with use of a second route BP image (#3) acquired on January 10, a second route BP image (#4) acquired on January 12, and a second route BP image (#5) acquired on January 14.

On the other hand, restoration of the backup data (backup image) can be performed with use of a first route BP image (#3) acquired on January 9, a first route BP image (#4) acquired on January 11, a first route BP image (#5) acquired on January 13, and the like in the period from the time of occurrence of the failure (January 15) to recovery of the failure (January 18).

In this manner, since the backup system according to the second embodiment stores first route BP images and second route BP images in the data protection area 33 such that generations of the first route BP images and the second route BP images alternate, the length of a generational interval over which data verification (restoration) is impossible is only the length corresponding to one generation even in a case where verification (restoration) with data of one route becomes impossible.

Accordingly, the backup system according to the second embodiment can lower the possibility that a generational interval over which data verification (restoration) is impossible becomes longer undesirably in a case where a failure has occurred in one backup volume. As a result, the backup system according to the second embodiment can verify/recover backup data at equal intervals (equal intervals every other generation) over the entire retention period even in a case where a failure has occurred in one backup volume. For example, on the contrary to the example described above in which data of three days cannot be verified at a time of occurrence of a volume failure of the BP storage 30 of the first backup route, backup images can be accessed at intervals of once in two cycles (two generations).

### Specific Operation

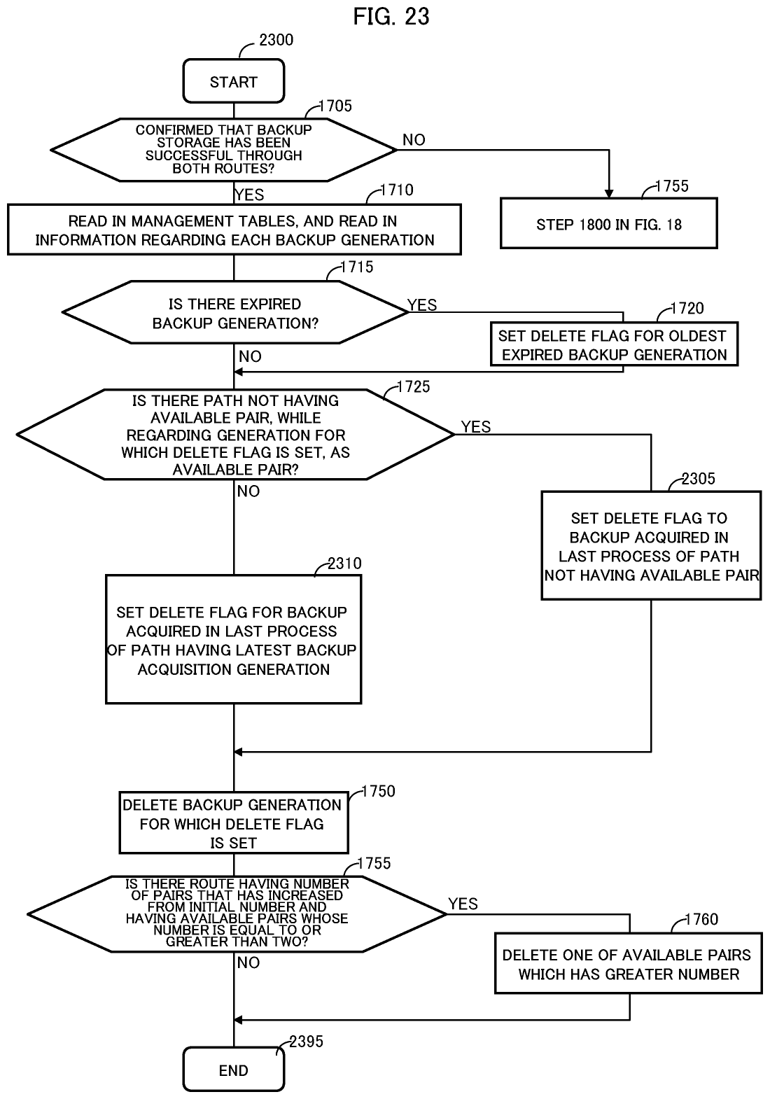

A specific operation performed by the backup system according to the second embodiment is explained. The backup system according to the second embodiment executes a processing procedure depicted in FIG. 23 instead of the processing procedure in FIG. 17, and executes the processing procedures in FIG. 18 and FIG. 19 described already. Explanations of the processing procedures in FIG. 18 and FIG. 19 described already are omitted. Hereinbelow, the processing procedure depicted in FIG. 23 is explained.

FIG. 23 is a flowchart depicting a processing procedure executed by the CPU 130 of the management server 100 of the backup system according to the second embodiment. This flowchart is the same as the flowchart in FIG. 17 except for that Step 1730 to Step 1745 in FIG. 17 are replaced with Step 2305 and Step 2310. Accordingly, detailed explanations of processes overlapping those in FIG. 17 are omitted in the following explanation.

The CPU 130 starts the process from Step 2300, and executes appropriate processes in Step 1705 to Step 1725 and Step 1755 described already.

When the CPU 130 proceeds to Step 1725, it assesses whether or not there is a backup path not having an available pair (i.e., whether or not there are available copy numbers of the backup volumes), while regarding a generation for which a delete flag is set (a copy number of the generation), as an available pair.

In a case where there is a backup path not having an available pair, the CPU 130 determines that the result of the assessment in Step 1725 is “YES,” proceeds to Step 2305, sets a delete flag to a backup (backup image) acquired in the last process through the path not having an available generation, and then proceeds to Step 1750.

In a case where there are no backup paths not having available pairs, the CPU 130 determines that the result of the assessment in Step 1725 is “NO,” proceeds to Step 2310, and sets a delete flag for a backup (backup image) acquired in the last process through a path having the latest backup acquisition generation. Thereafter, the CPU 130 proceeds to Step 1750.

When the CPU 130 proceeds to Step 1750, the CPU 130 executes the processes described already, thereafter executes an appropriate process in Step 1755 and Step 1760 described already, then proceeds to Step 2395, and temporarily ends the present processing flow. In the backup system, by the CPU 130 of the management server 100 executing such a processing procedure, the BP storage 30 can actively store first route BP images and second route BP images in the data protection area 33 such that generations of the first route BP images and the second route BP images alternate.

### Advantages

As explained above, the backup system according to the second embodiment can improve availability by increasing the number of paths (to two in the present example) through which backup data to be stored in the data protection area 33 is acquired. Further, the backup system according to the second embodiment can efficiently use the capacity of the data protection area 33, and store a greater number of generations of backup data in the data protection area 33 with limited capacity by storing duplicated pieces of backup data in the data protection area 33 such that generations of the duplicated pieces of backup data do not overlap. Further, the backup system according to the second embodiment can verify/recover backup data at equal intervals over the entire retention period also in a case where a failure has occurred.

### Modification Examples

The present invention is not limited to each embodiment described above, and can adopt various modification examples within the scope of the present invention. Further, each embodiment described above and modification examples described below can be combined with each other as long as such combinations do not depart from the scope of the present invention.

Whereas the number of backup routes is two for one backup-target production in each embodiment described above, the number of backup routes for one production may be equal to or greater than three.

In this case, for example, the present invention can also adopt the following configurations [1] and [2].

[1]

A backup system including:
a plurality of storage apparatuses each of which is used to configure one of a plurality of backup routes that are different for a common backup target; and
a backup storage apparatus having a plurality of backup volumes corresponding to a plurality of the backup routes and a data protection area that is a storage area not accessible from an external apparatus, in which
the backup storage apparatus
   stores each copy of common backup-target data in one of a plurality of the backup volumes through one of a plurality of the backup routes; and
   stores backup images of a plurality of generations for respective ones of a plurality of the backup volumes in the data protection area.
      [2]

A backup method using
a plurality of storage apparatuses, and
a backup storage apparatus having a plurality of backup volumes and a data protection area that is a storage area not accessible from an external apparatus,
the backup method including:
forming a plurality of backup routes that are different for a common backup target, by a plurality of the storage apparatuses;
storing, by the backup storage apparatus, each copy of common backup-target data in one of a plurality of the backup volumes through one of a plurality of the backup routes; and
storing, by the backup storage apparatus, backup images of a plurality of generations for respective ones of a plurality of the backup volumes in the data protection area.

In each embodiment described above, one of duplicated pieces of backup data (backup images) acquired through two routes may not be deleted, and may be stored in the data protection area 33 as it is. In this case also, availability can be improved. Note that the use efficiency of the capacity of the data protection area 33 lowers as compared with each embodiment described above.

In each embodiment described above, the access volume 35 may be used as a verification volume. That is, upon reception of a restoration instruction from the verifying server 200, the BP storage links a copy number corresponding to a backup image of a specified generation with the access volume 35. The BP storage mounts the access volume in the verifying server 200. As a result, the verifying server 200 can read out and verify the backup image stored in the data protection area, by accessing the access volume 35.

What is claimed is:

1. A backup system comprising:
a plurality of storage apparatuses each of which is used to configure one of a plurality of backup routes that are different for a common backup target; and
a backup storage apparatus having a plurality of backup volumes corresponding to a plurality of the backup routes and a data protection area that is a storage area not accessible from an external apparatus, wherein
the backup storage apparatus
stores each copy of common backup-target data in one of a plurality of the backup volumes through one of a plurality of the backup routes, and
stores backup images of a plurality of generations for respective ones of a plurality of the backup volumes in the data protection area.

2. The backup system according to claim 1, wherein
the backup storage apparatus stores the backup images of the plurality of generations in the data protection area such that generations of the backup images do not overlap.

3. The backup system according to claim 1, further comprising:
a first storage apparatus and a second storage apparatus as a plurality of the storage apparatuses, wherein
the backup storage apparatus
includes a first backup volume corresponding to the first storage apparatus and a second backup volume corresponding to the second storage apparatus as a plurality of the backup volumes, and
stores first route BP images as backup images for the first backup volume and second route BP images as backup images for the second backup volume in the data protection area such that generations of the first route BP images and generations of the second route BP images do not overlap.

4. The backup system according to claim 3, wherein
the backup storage apparatus stores the first route BP images and the second route BP images in the data protection area such that a difference between the number of the generations of the first route BP images and the number of the generations of the second route BP images decreases.

5. The backup system according to claim 3, wherein
the backup storage apparatus stores the first route BP images and the second route BP images in the data protection area such that the generation of the first route BP images and the generation of the second route BP images alternate.

6. The backup system according to claim 3, wherein,
the backup storage apparatus,
in a case where the backup storage apparatus has been able to store both a first route BP image and a second route BP image of a same backup acquisition date/time in the data protection area,
deletes an expired first route BP image and second route BP image that are stored in the data protection area, and
deletes one of a first route BP image and a second route BP image such that a difference between the numbers of the generations of the first route BP images and the second route BP images that are stored in the data protection area decreases.

7. The backup system according to claim 6, wherein,
the backup storage apparatus,
in a case where the backup storage apparatus has succeeded in acquisition of only one of a first route BP image and a second route BP image as backup images through one of the backup routes and has been able to store only one of a first route BP image and a second route BP image of a same backup acquisition date/time in the data protection area,
deletes the expired first route BP image and second route BP image that are stored in the data protection area, and
adds an available pair to one of the first backup volume and the second backup volume corresponding to one of the backup routes.

8. The backup system according to claim 7, wherein,
the backup storage apparatus,
in a case where the backup storage apparatus has been able to store both a first route BP image and a second route BP image of a same generation in the data protection area after the addition of the available pair to the one of the backup volumes, deletes the added available pair which has become unnecessary.

9. The backup system according to claim 3, wherein,
the backup storage apparatus,
in a case where the backup storage apparatus has been able to store both a first route BP image and a second route BP image of a same generation in the data protection area,
deletes either of an expired first route BP image and second route BP image that are stored in the data protection area, and
deletes one of a first route BP image and a second route BP image such that the generations of the first route BP images and the second route BP images that are stored in the data protection area alternate.

10. The backup system according to claim 9, wherein,
the backup storage apparatus,
in a case where the backup storage apparatus has succeeded in acquisition of only one of a first route BP image and a second route BP image through one of the backup routes and has been able to store only one of a first route BP image and a second route BP image in the data protection area,
deletes the expired first route BP image and second route BP image that are stored in the data protection area, and
adds an available pair to one of the first backup volume and the second backup volume corresponding to one of the backup routes.

11. The backup system according to claim 10, wherein,
the backup storage apparatus,
in a case where the backup storage apparatus has been able to store both a first route BP image and a second route BP image of a same generation in the data protection area after the addition of the available pair to the one of the backup volumes, deletes the added available pair which has become unnecessary.

12. The backup system according to claim 2, further comprising:
an information processing apparatus including a computing device and a storage device, wherein
the storage device stores
backup route management information including, in association with each other, backup target identification information for identifying backup targets and backup route identification information that is identification information for identifying the backup routes, and
backup generation information including, in association with each other, the backup route identification information and information regarding the backup images corresponding to the backup routes represented by the backup route identification information, and
the computing device is configured to
identify the backup route identification information corresponding to the input backup target identification information on a basis of the backup route management information,
identify information regarding the backup images corresponding to the identified backup route identification information on a basis of the backup generation information, and
create integrated backup generation information including information regarding the backup images of a plurality of generations stored in the data protection area regarding the backup targets, by integrating the identified information regarding the backup images.

13. The backup system according to claim 12, further comprising:
a display device that can display an image, wherein
the information processing apparatus is configured to display, on the display device, a graphical user interface screen including information regarding the backup images of the plurality of generations stored in the data protection area, on a basis of the integrated backup generation information.

14. The backup system according to claim 13, wherein
the backup storage apparatus has an access volume that is accessible from an external apparatus, and
the backup storage apparatus identifies a copy number given to a backup volume and a backup image corresponding to a generation selected through the graphical user interface screen, and makes the backup image corresponding to the identified copy number of the backup volume accessible from the external apparatus through the access volume.

15. A backup method using
a plurality of storage apparatuses, and
a backup storage apparatus having a plurality of backup volumes and a data protection area that is a storage area not accessible from an external apparatus,
the backup method comprising:
forming a plurality of backup routes that are different for a common backup target, by a plurality of the storage apparatuses;
storing, by the backup storage apparatus, each copy of common backup-target data in one of a plurality of the backup volumes through one of a plurality of the backup routes; and
storing, by the backup storage apparatus, backup images of a plurality of generations for respective ones of a plurality of the backup volumes in the data protection area.
